(19) United States
(12) Patent Application Publication
(10) Pub. No.: US 2014/0152687 A1
(43) Pub. Date: Jun. 5, 2014

(54) Color management system based on universal gamut mapping method

(71) Applicants: Travis Liu, Heidelbert Heights (AU); Shichang Liu, Xi'an (CN); Yun Liu, Port Moody (CA)

(72) Inventors: Travis Liu, Heidelbert Heights (AU); Shichang Liu, Xi'an (CN); Yun Liu, Port Moody (CA)

(21) Appl. No.: 13/818,303

(22) PCT Filed: Oct. 17, 2011
(86) PCT No.: PCT/CN2011/001729

§ 371 Date: Feb. 22, 2013

(51) Int. Cl. H04N 1/60; G09G 5/02

(52) U.S. Cl. CPC H04N 1/6058; G09G 5/026
USPC 345/590; 358/1.9

(57) ABSTRACT

This invention is a universal gamut mapping and color management method and relates to color digital image processing technical field. It involves high-accuracy image coordinates conversion in device color space, high fidelity chroma transmission between input and output devices, cross-media gamut mapping technologies and color management system built based on these technologies.

This invention is accurate, efficient and versatile. It can be widely used in image processing hardware manufacture and software design for image transmission and receiving devices such as computer, digital TV, digital image displays, digital video camera and television camera, etc. Technical features of this method: eliminates red-shift interference, keeps 3 primary colors' independency and channel independency during color synthesis and segmentation, gives priority to grey component reproduction, transfers luminance and chromaticity data in accordance with luminance independent theory, new Dₗxₗyₗ profile connection space, accurate color prediction and gamut mapping equation, etc. The combination of all these features guarantees the versatility of this method.

### I. TECHNICAL FIELD

This invention is a brand new, practical technology of cross-media image transmission and accurate color image reproduction conform to visual effect. Its main application involve image display devices (e.g. CRT, PDP, LCD or LED monitors), image output devices (e.g. color printers, multicolor offset press, re mote image transmission, image mobile communication, network image exchange), associated design and production fields (e.g. color management system, computer image system, multimedia television system, image sending and receiving system). It introduces a universal and innovative technical solution to software production and hardware manufacture of above system and devices.

### II. TECHNICAL BACKGROUND

In current color management system, CIE LAB (CIECAM02) is commonly used as PCS (profile connection space). However, both color systems CIE LAB and CIECAM02 have errors which cannot be neglected. When CMM (color management module) transfer CIE XYZ into RGB or CMYK color space data, device and media have variant attenuation on X, Y, Z values, which result in complex non-linear relationship between CIE XYZ and RGB or CMYK. Until now the method to resolve this non-linear relationship is neither unified nor accurate, as it failed to maintain color property independence, channel independence and gray component independence during 3 primary color-matching processes. It doesn't take ‘red shift’ effect of primary colors into consideration either. As a result, people have to use look-up table method to resolve practical difficulties; look-up table method is complicated and the conversion result is lack of uniqueness. As to color image reproduction, cross-media gamut mapping is hard to achieve due to lack of universal gamut mapping method. Till now the objective of ‘what you see is what you get’ still haven't be met yet. In this technology background, this invention takes a new approach to create a universal cross-media gamut mapping method, which ensures a unified principle, method and mathematical description model can be used through the whole color management system. The new approach establishes the steps of improving gamut mapping accuracy at the profiling stage to ensure the accuracy of color prediction. The use of new gamut mapping method and the analytic calculation method not higher than quadratic ensures both the gamut mapping accuracy and production efficiency. This method is transparent, has routine procedure and unique result. It offers more opportunity for enterprise participation and makes it possible to maximum the potential use of devices.

### III. DESCRIPTION OF THE INVENTION

This invention successfully creates an innovative and unified color gamut mapping system by solving following major problems:

(1) In process of three primary color reproduction, it is essential to maintain constant primary property. Currently Marry-Davis formula, Yule-Nielson formula and GOG colorimetric prediction model are not accurate enough;

(2) In color matching space, 3 primary colors should not only maintain their own hue property independent, but also maintain space independency in each channel; However current color transformation method and mathematical model, such as Neugebauer formula and conventionally color space matrix conversion equation, cannot meet these requirements;

(3) Correct gray tone reproduction should be priority in color image reproduction. This involves gray balance, gray balance curve setting, visual adaption and Gamma correction to media attenuation effect. With traditional gamut mapping technology, gray and color reproduction interface and constraint with each other, therefore cannot ensure prioritized, independent reproduction of gray tone and cause obvious color reproduction error in certain gamut area;

(4) So-called uniform color space CIE 1876 L*a*b* and CIE 1976 L*u*v* are not uniform, so it cannot ensure accuracy in gamut mapping and color transformation; this invention introduces Dₗxₗyₗ profile connection space to solve this problem, and detailed process of transforming Dₗxₗyₗ will be discussed in following content;

(5) Existing technology cannot resolve the conflict between complexity of transformation model and algorithmic efficiency, so look-up table method is seen as resolution; However look-up table method cannot ensure uniqueness of image mapping and continuity of gamut mapping; as equipment aging and property offset always happen over time, it is hard for users to take corrective measure;

(6) Existing gamut mapping method is lack of uniform process principle and method to deal with diversity of cross-media color input and output devices; existing gamut mapping technology is based on flawed theory which incurs random and systematic error;

This invention creates a brand new color mapping method to overcome above challenges and ensures color to be mapped keep its original hue, chromaticity coordinates and luminance For easy understanding of the unconventional approaches, first we introduce basic common method used by various devices in mapping system and related mathematic model. Later we will integrate all these fundamental inventions to form a complete color-mapping system.

Please note, in this document we use unified naming convention and label symbol in mathematical models; we only provide description of the math symbol when it is used the first time.

1. A color target structure commonly used by input, display and output devices with identical driving values.

Objective and usage: this step mainly resolves the unified calibration problem among various devices. In order to calibrate the input, display and output device, it creates a common, connected color target structure. Perform the calibration using sample color with the same driving value and corresponding hue among different devices. The objective is to define a unified input standard for different devices in color management system, and achieve a mapping result with continuity and inheritance features.

Color target's structure and generation steps:

(1) Define the basic input data. The basic input data is the measured tristimulus value of sample color when creating profile for input, display and output devices. The sample colors on the color target are:

(a) Three primary scale of Monochromatic color: set the driving value to 21 levels in the range of 0 to 20, let scale number i=21. For monitor, set the 21 driving values dᵣᵢ, d_{gi}, d_{bi} of three primary to: 0.00, 12.75, 25.50, 38.25, 51.00, 63.75, 76.50, 89.25, 102.00, 114.75, 127.50, 140.25, 153.00, 165.75, 178.50, 191.25, 204.00, 216.75, 229.50, 242.25, 255.00, display and measure each color produced by the driving value on monitor. For calibration color target like digital camera or television camera, create photographic paper color target using same data set.

For printer or scanner color target, set the 21 driving values of three primary colors (cmy) d_{ci}, dₘᵢ, d_{yi} to 0%=0.00/255, 5%=12.75/255, 10%=25.50/255, 15%=38.25/255, 20%=51.00/255, 25%=63.75/255, 30%=76.50/255, 35%=89.25/255, 40%=102.00/255, 45%=114.75/255, 50%=127.50/255, 55%=140.25/255, 60%=153.00/255, 65%=165.75/255, 70%=178.50/255, 75%=191.25/255, 80%=204.00/255, 85%=216.75/255, 90%=229.50/255, 95%=242.25/255, 100%=255/255;

For printer color target, a 21 level monochromatic blank ink scale needs to be added, the driven variable is dₓᵢ.

(b) Secondary color sample: for monitor, they are three secondary color produced by three sets of driving value (dᵣ255+d_{g}255), (dᵣ255+d_{b}255), (d_{g}255+d_{b}255). For printer and scanner, they are three secondary color produced by (d_{c}100%+dₘ100%), (dₘ100%+d_{y}100%), (d_{c}100%+d_{y}100%). For CMYK 4-primary printer, the following three secondary color produced by
(d_{c}100%+dₖ100%), (dₘ100%+dₖ100%), (d_{y}100%+dₖ100%) needs to be added;

(c) Tertiary color sample: for monitor, they are gray sample sets with same driving value (dᵣᵢ+d_{gi}+dₜᵢ) and display sequentially with parameter value ranging from 0 to 255 following color additive process. For printer and scanner, they are gray sample sets with the same driving value (d_{ci}+dₘᵢ+d_{yi}), parameter value ranging from 0 to 100%. Although the color target structure of printer and scanner are the same, the material to produce the scanner target and printer target are not the same and tristimulus of sample color are not identical. When creating the profile using color target, the tristimulus values of sample color need to be measured. Scanner's calibration color target can be simulated using photographic paper. For CMYK four color printer, three tertiary color produced by (d_{c}100%+dₘ100%+dₖ100%), (dₘ100%+d_{y}100%+dₖ100%), (d_{c}100%+d_{y}100%+dₖ100%) and a mixed color produced by (d_{c}100%+dₘ100%+d_{y}100%+dₖ100%) need to be added as well. Please notes letter d represents the scale driving variable parameter. Because CMYK is commonly used to represent the input value of printer device and RGB are commonly used to represent driving value of display and scanner device, we use C, M, Y, K, R, G, B to represent the calculated data value of variable d_{ci}, dₘᵢ, d_{yi}, dₖᵢ, dᵣᵢ, d_{gi}, d_{bi}. In order to calculate the CIEXYZ value of the scanned color later on, not only the CIEXYZ value of the sample color needs to be measured using spectrophotometer, but also the RGB average value of every sample color needs to be captured with the help of software.

2. A unified method to keep primary color channel independence for input, display and output devices

Objective: as a key process in the new gamut mapping method, it ensures every primary color component that involves in color-matching has constant hue. The primary color channel independency is essential to color mixing and gamut mapping. Existing technologies, e.g. Marry-Davis formula, Yule-Nielson formula, Gain-Offset-Gamma formula can't guarantee the primary color involves in the color matching has constant hue. For example, when calculating the dot area using Marry-Davis formula and Yule-Nielson formula, the calculated dot area result is a fuzzy value between geometry gain and optical gain. The objective of this method is to resolve this problem.

Method: when driving value varies between 0-255, let all the primary and unit primary have the same hue. If use mathematical way to explain this method, this invention uses Liu's primary clamping equation and the derived Liu's primary formula to clamp the primary hue, colorfulness and luminance and ensure independence of primary's hue.

3 steps to keep primary channel independence:

Subtractive primary clamping equation and reference primary formula are used as an example.

Step 1, Measure the tristimulus value of printing sample color on primary color target using spectrophotometer, given the measured value as XYZ, measure the tristimulus value of white dot X_{w}, Y_{w}, Z_{w} and primary solid tristimulus value Xₛ, Yₛ, Zₛ. Given the primary solid tristimulus value Xₛ, Yₛ, Zₛ as the unit primary value of the primary, the following Liu's primary clamping equation represents the relationship between clamping primary value aₜ, clamping luminance Yₜ and color appearance keeping parameter λ:

$$\{ \begin{matrix}λ X = ( 1 - {a}_{t} ) {X}_{w} + {a}_{t} {X}_{s} \\ λ {Y}_{t} = ( 1 - {a}_{t} ) {Y}_{w} + {a}_{t} {Y}_{s} \\ λ Z = ( 1 - {a}_{t} ) {Z}_{w} + {a}_{t} {Z}_{s}\end{matrix}$$

This clamping equation is applicable to printer color target, scanner color target and normally-white-monitor color target. It can also be called as printer primary clamping equation, scanner primary clamping equation and normally-white-monitor primary clamping equation.

Step 2, solve above Liu's primary clamping equation, and get sample color's clamping luminance Yₜ; analytical expression of Yₜ is as follows, with which we can calculate sample color's clamping luminance Yₜ:

$${Y}_{t} = \frac{( {Y}_{w} - {Y}_{s} ) \{ \begin{matrix}Z [ {X}_{w} ( {Y}_{w} - {Y}_{s} ) - {Y}_{w} ( {X}_{w} - {X}_{s} ) ] - \\ X [ {Z}_{w} ( {Y}_{w} - {Y}_{s} ) - {Y}_{w} ( {Z}_{w} - {Z}_{s} ) ]\end{matrix} \}}{\begin{matrix}( {Z}_{w} - {Z}_{s} ) [ {X}_{w} ( {Y}_{w} - {Y}_{s} ) - {Y}_{w} ( {X}_{w} - {X}_{s} ) ] - \\ ( {X}_{w} - {X}_{s} ) [ {Z}_{w} ( {Y}_{w} - {Y}_{s} ) - {Y}_{w} ( {Z}_{w} - {Z}_{s} ) ]\end{matrix}}$$

Step 3, Take clamping luminance Yₜ into Liu's reference primary value equation, and get sample color's reference primary value a;

Liu's reference primary value equation is:

$$a = \frac{{Y}_{w} - {Y}_{t}}{{Y}_{w} - {Y}_{s}}$$

As shown in above formula, if we let unit primary value=1, then primary value (also called dot area in printing industry) varies between 0 1. When applying Liu's primary clamping equation and Liu's reference primary value equation in various occasions, user should discern specific meaning of parameters in formula. For instance, for printer, primary value a stands for primary value of primary c, m, y (cyan, magenta, yellow); for monitor, a stands for values of primary r, g, b (red, green, blue):

$$c = \frac{{Y}_{w} - {Y}_{t}}{{Y}_{w} - {Y}_{c}} , \qquad m = \frac{{Y}_{w} - {Y}_{t}}{{Y}_{w} - {Y}_{m}} , \qquad y = \frac{{Y}_{w} - {Y}_{t}}{{Y}_{w} - {Y}_{y}} ,$$

$$\begin{matrix}r = \frac{{Y}_{w} - {Y}_{t}}{{Y}_{w} - {Y}_{r}} , & g = \frac{{Y}_{w} - {Y}_{t}}{{Y}_{w} - {Y}_{g}} ,\end{matrix} \qquad b = \frac{{Y}_{w} - {Y}_{t}}{{Y}_{w} - {Y}_{b}}$$

c, m, y is so-called dot area in printing industry; if performing calibration calculation on normally-white LCD, LED monitor, the reference primary value ‘a’ represents the primary value of red r, green g or blue b etc. The normally-black primary clamping equation and primary value formula for TV monitor can be reference in specification of patent PCT/2011/000327.

When creating the profile for scanner, not only the tristimulus value Xᵢ, Yᵢ, Zᵢ of the 3 primary color scale on the scanner color target needs to be measured, the sample color's tristimulus value Rᵢ, Gᵢ, Bᵢ on the scale also needs to be collected using the data collection software module. Because Xᵢ, Yᵢ, Zᵢ and Rᵢ, Gᵢ, Bᵢ actually describe the same sample color in different color space, Liu's clamping equation can be slightly modified to substitute the character X,Y,Z with R,B,G. The updated equation is as follows:

$$\{ \begin{matrix}λ R = ( 1 - {a}_{t} ) {R}_{w} + {a}_{t} {R}_{s} \\ λ {G}_{t} = ( 1 - {a}_{t} ) {G}_{w} + {a}_{t} {G}_{s} \\ λ B = ( 1 - {a}_{t} ) {B}_{w} + {a}_{t} {B}_{s}\end{matrix}$$

Apparently this is a characteristic property of scanner device. For the purpose of distinguishing, it is named as RGB scanner clamping equation in this invention, and the former is named as XYZ scanner clamping equation, which is used when performing RGB-CMY color space transformation on scanned sample color. The clamping luminance Gₜ and reference primary value a can be calculated with the RGB scanner clamping equation. The formula is as follows:

$${G}_{t} = \frac{( {G}_{w} - {G}_{s} ) \{ \begin{matrix}B [ {R}_{w} ( {G}_{w} - {G}_{s} ) - {G}_{w} ( {R}_{w} - {R}_{s} ) ] - \\ R [ {B}_{w} ( {G}_{w} - {G}_{s} ) - {G}_{w} ( {B}_{w} - {B}_{s} ) ]\end{matrix} \}}{\begin{matrix}( {B}_{w} - {B}_{s} ) [ {R}_{w} ( {G}_{w} - {G}_{s} ) - {G}_{w} ( {R}_{w} - {R}_{s} ) ] - \\ ( {R}_{w} - {R}_{s} ) [ {B}_{w} ( {G}_{w} - {G}_{s} ) - {G}_{w} ( {B}_{w} - {B}_{s} ) ]\end{matrix}}$$

$$a = \frac{{G}_{w} - {G}_{t}}{{G}_{w} - {G}_{s}}$$

Benefit of the invention: clamping luminance Yₜ derived from primary clamping equation suppresses interference from ‘red shift’ which reducing accuracy of calculated primary values. Primary value a obtained with Liu's primary value equation rules out such interference, therefore color represented by reference primary value a has same hue as unit primary value, and tristimulus value of this primary value is no longer equal to measured tristimulus value X, Y, Z, they are modified to X, Yₜ, Z. In following content, reference primary value will be used as independent parameter in color-matching or 3-primary color-matching equation, and it provides a precise solution for normalized, systematic and accurate 3-primary color-matching method.

3. The method to keep primary' independence in three channels of color-matching space and Liu's color-matching equation

Method: amongst current technologies, Neugebauer and Masking formula are typical methods to perform 3-primary color-matching. However the independency of the primary parameter is poor in three channels due to the crosstalk between channels. The calculation error could be greater than 10.

From 1937 till now, many improvement methods have been proposed, but all failed to achieve expected accuracy. The popular Look-up table (LUT) algorithm based on interpolation approximation algorithm is a simulation algorithm which cannot provide accurate color gamut mapping result. This invention set a ‘channel primary value’ parameter for each color-matching channel. The channel primary value can be further transformed into the function of reference primary color value parameter. Meantime, conversion between primary value parameter and driving parameter to produce the primary color is accurate and reversible. The equation built based on this method can ensure 3 primary plays independent roles during color-matching in color-matching space.

Types of Liu's color-matching equation:

(1) Liu's subtractive color-matching equation based on subtractive color reproduction:

In this invention, there are two uses of Liu's subtractive color-matching equation:

Firstly, it can be used to create gray balance equation for primary cmy in Liu's four color-matching equations; secondly, it can be used as color prediction equation for scanners. For the purpose of distinguishing, Liu's subtractive color-matching equation is called 3-primary printing color-matching equation in the first use and scanning color prediction equation in the second use. Liu's subtractive color-matching equation is as follows:

$$\{ \begin{matrix}X = \begin{matrix}( 1 - {y}_{x } ) ( 1 - {m}_{x} ) ( 1 - {c}_{x} ) {X}_{w} + ( 1 - {y}_{x} ) ( 1 - {m}_{x} ) {c}_{x} {X}_{c} + ( 1 - {y}_{x} ) {m}_{x} ( 1 - {c}_{x} ) {X}_{m} + {y}_{x} ( 1 - {m}_{x} ) ( 1 - {c}_{x} ) {X}_{y} + \\ {y}_{x} {m}_{x} ( 1 - {c}_{x} ) {X}_{r} + {y}_{x} ( 1 - {m}_{x} ) {c}_{x} {X}_{g} + ( 1 - {y}_{x} ) {m}_{x} {c}_{x} {X}_{b} + {y}_{x} {m}_{x} {c}_{x} {X}_{s}\end{matrix} \\ Y = \begin{matrix}( 1 - {y}_{y } ) ( 1 - {m}_{y} ) ( 1 - {c}_{y} ) {Y}_{w} + ( 1 - {y}_{y} ) ( 1 - {m}_{y} ) {c}_{y} {Y}_{c} + ( 1 - {y}_{y} ) {m}_{y} ( 1 - {c}_{y} ) {Y}_{m} + {y}_{y} ( 1 - {m}_{y} ) ( 1 - {c}_{y} ) {Y}_{y} + \\ {y}_{y} {m}_{y} ( 1 - {c}_{y} ) {Y}_{r} + {y}_{y} ( 1 - {m}_{y} ) {c}_{y} {Y}_{g} + ( 1 - {y}_{y} ) {m}_{y} {c}_{y} {X}_{b} + {y}_{y} {m}_{y} {c}_{y} {Y}_{s}\end{matrix} \\ Z = \begin{matrix}( 1 - {y}_{z } ) ( 1 - {m}_{z} ) ( 1 - {c}_{z} ) {Z}_{w} + ( 1 - {y}_{z} ) ( 1 - {m}_{z} ) {c}_{z} {Z}_{c} + ( 1 - {y}_{z} ) {m}_{z} ( 1 - {c}_{z} ) {Z}_{m} + {y}_{z} ( 1 - {m}_{z} ) ( 1 - {c}_{z} ) {Z}_{y} + \\ {y}_{z} {m}_{z} ( 1 - {c}_{z} ) {Z}_{r} + {y}_{z} ( 1 - {m}_{z} ) {c}_{z} {Z}_{g} + ( 1 - {y}_{z} ) {m}_{z} {c}_{z} {Z}_{b} + {y}_{z} {m}_{z} {c}_{z} {Z}_{s}\end{matrix}\end{matrix}$$

In above equation, XYZ on left side represents tristimulus value of the color to be matched. The tristimulus X_{w}Y_{w}Z_{w}, X_{c}Y_{c}Z_{c}, XₘYₘZₘ, X_{y}Y_{y}Z_{y}, XᵣYᵣZᵣ, X_{g}Y_{g}Z_{g}, X_{b}Y_{b}Z_{b}, XₛYₛZₛ represent 8 solid colors (white, cyan, magenta, yellow, red, green, blue, black mixed with 3 primary) measured on color target respectively. Please note when dealing with scanner, tristimulus value of 8 solid colors on scanner color target needs to be measured; when dealing with printing device, tristimulus value of 8 solid colors on color target of printing device needs to be measured; this won't be repeated in following content. Variable yₓ, y_{y}, y_{z}, mₓ, m_{y}, m_{z}, cₓ, c_{y}, c_{z} represent channel primary value of yellow, magenta, cyan.

Channel primary parameter cₓ, c_{y}, c_{z} are functions of reference primary value c;

mₓ, m_{y}, m_{z} are functions of reference primary value m;

yₓ, y_{y}, y_{z} are functions of reference primary value y. The format of the function is:

cₓ=c^{γ}^{_{xc}}, c_{y}=c^{γ}^{_{yc}}, c_{z}=c^{γ}^{_{zc}}, mₓ=m^{γ}^{ₓₘ}, m_{y}=m^{γ}^{_{ym}}, m_{z}=m^{γ}^{_{zm}}, yₓ=y^{γ}^{_{xy}}, y_{y}=y^{γ}^{_{yy}}, y_{z}=y^{γ}^{_{zy}}

Please note primary value parameter c, m and y are functions of driving parameters d_{d}, dₘ, d_{y}, the functions are as follows:

c=d_{c}^{γc}, m=dₘ^{γm}, y=d_{y}^{γy}, the inverse solutions are:

d_{c}=c^{1/γc}, dₘ=m^{1/γm}, d_{y}=y^{1/γy}

(2) Liu's 4 primary color-matching equation:

This color-matching equation is an extension of above Liu's subtractive color-matching equation. For printer and press machine, cmyk 4-primary reproduction is standard reproduction method. When k=0 or k is a known value, 4-primary color-matching equation degenerates to the normal Liu's subtractive color prediction equation which is back to the standard three primary reproduction process. Liu's 4-primary equation is as follows:

$$\{ \begin{matrix}X = \begin{matrix}( 1 - {c}_{x} ) ( 1 - {m}_{x} ) ( 1 - {y}_{x} ) ( 1 - {k}_{dd} ) {X}_{w} + {c}_{x} ( 1 - {m}_{x} ) ( 1 - {y}_{x} ) ( 1 - {k}_{dd} ) {X}_{c} + ( 1 - {c}_{x} ) {m}_{x} ( 1 - {y}_{x} ) ( 1 - {k}_{dd} ) {X}_{m} + \\ ( 1 - {c}_{x} ) ( 1 - {m}_{x} ) {y}_{x} ( 1 - {k}_{dd} ) {X}_{y} + ( 1 - {c}_{x} ) {m}_{x} {y}_{x} ( 1 - {k}_{dd} ) {X}_{r} + {c}_{x} ( 1 - {m}_{x} ) {y}_{x} ( 1 - {k}_{dd} ) {X}_{g} + \\ {c}_{x} {m}_{x} ( 1 - {y}_{x} ) ( 1 - {k}_{dd} ) {X}_{b} + {c}_{x} {m}_{x} {y}_{x} ( 1 - {k}_{dd} ) {X}_{s} + ( 1 - {c}_{x} ) ( 1 - {m}_{x} ) ( 1 - {y}_{x} ) {k}_{dd} {X}_{k} + \\ {c}_{x} ( 1 - {m}_{x} ) ( 1 - {y}_{x} ) {k}_{dd} {X}_{ck} + ( 1 - {c}_{x} ) {m}_{x} ( 1 - {y}_{x} ) {k}_{dd} {X}_{mk} + ( 1 - {c}_{x} ) ( 1 - {m}_{x} ) {y}_{k} {k}_{dd} {X}_{yk} + \\ ( 1 - {c}_{x} ) {m}_{x} {y}_{x} {k}_{dd} {X}_{rk} + {c}_{x} ( 1 - {m}_{x} ) {y}_{x} {k}_{dd} {X}_{gk} + {c}_{x} {m}_{x } ( 1 - {y}_{x} ) {k}_{dd} {X}_{bk} + {c}_{x} {m}_{x} {y}_{x} {k}_{dd} {X}_{sk}\end{matrix} \\ Y = ( 1 - {c}_{y} ) ( 1 - {m}_{y} ) ( 1 - {y}_{y} ) ( 1 - {k}_{dd} ) {Y}_{w} + {c}_{y} ( 1 - {m}_{y} ) ( 1 - {y}_{y} ) ( 1 - {k}_{dd} ) {Y}_{c} + … + {c}_{y} {m}_{y} {y}_{y} {k}_{dd} {Y}_{sk} \\ Z = ( 1 - {c}_{z} ) ( 1 - {m}_{z} ) ( 1 - {y}_{z} ) ( 1 - {k}_{dd} ) {Z}_{w} + {c}_{z} ( 1 - {m}_{z} ) ( 1 - {y}_{z} ) ( 1 - {k}_{dd} ) {Z}_{c} + … + {c}_{z } {m}_{z } {y}_{z} {k}_{dd} {Z}_{sk}\end{matrix}$$

Variable yₓ, y_{y}, y_{z}, mₓ, m_{y}, m_{z}, cₓ, c_{y}, c_{z} have the same definition and function as they are in Liu's subtractive color-matching equation, which is:

cₓ=c^{γ}^{_{xc}}, c_{y}=c^{γ}^{_{yc}}, c_{z}=c^{γ}^{_{zc}}, mₓ=m^{γ}^{ₓₘ}, m_{y}=m^{γ}^{_{ym}}, m_{z}=m^{γ}^{_{zm}}, yₓ=y^{γ}^{_{xy}}, y_{y}=y^{γ}^{_{yy}}, y_{z}=y^{γ}^{_{zy}}

Primary parameter c, m, y are the function of driving parameter d_{d}, dₘ, d_{y}.

The function is:

c=d_{c}^{γc}, m=dₘ^{γm}, y=d_{y}^{γy}

The inverse-solutions are:

d_{c}=c^{1/γ}^{_{c}}, dₘ=m^{1/γ}^{ₘ}, d_{y}=y^{1/γ}^{_{y}}

The measured value of color target in the equation is same as in printing 3-primary color-matching equation. k_{dd} represents gray component substitute value in black ink. Given k as the reference primary of black ink, k_{dd} represents gray component substitute value in 4-primary reproduction. This will be covered in detail later. Although it appears there are 4 parameters c, m, y, k in the equation, the 4-primary color-matching equation actually is still 3 primary equation with variable c, m, y because k_{dd} is a known pre-defined value. When the equation is used for calibration calculation, the iterative method can be implemented to solve the equation.

(3) Liu's normally-white-monitor color-matching equation(for computer) based on additive color reproduction

In order to create profile for normally-white CRT, PDP, LCD and LED monitor and derive the gray balance power function for normally-white-monitor, the following Liu's normally-white additive color-matching equation is used:

$$\{ \begin{matrix}X = \begin{matrix}( 1 - {b}_{x} ) ( 1 - {g}_{x} ) ( 1 - {r}_{x} ) {X}_{w} + ( 1 - {b}_{x} ) ( 1 - {g}_{x} ) {r}_{x} {X}_{r} + ( 1 - {b}_{x} ) {g}_{x} ( 1 - {r}_{x} ) {X}_{g} + {b}_{x} ( 1 - {g}_{x} ) ( 1 - {r}_{x} ) {X}_{b} + \\ {b}_{x} {g}_{x} ( 1 - {r}_{x} ) {X}_{c} + {b}_{x} ( 1 - {g}_{x} ) {r}_{x} {X}_{m} + ( 1 - {b}_{x} ) {g}_{x} {r}_{x} {X}_{y} + {b}_{x} {g}_{x} {r}_{x} {X}_{sk}\end{matrix} \\ Y = ( 1 - {b}_{y} ) ( 1 - {g}_{y} ) ( 1 - {r}_{y} ) {Y}_{w} + ( 1 - {b}_{y} ) ( 1 - {g}_{y} ) {r}_{y} {Y}_{r} + ( 1 - {b}_{y} ) {g}_{y} ( 1 - {r}_{y} ) {Y}_{g} + … + {b}_{y} {g}_{y} {r}_{y} {Y}_{sk} \\ Z = ( 1 - {b}_{z} ) ( 1 - {g}_{z} ) ( 1 - {r}_{z} ) {Z}_{w} + ( 1 - {b}_{z} ) ( 1 - {g}_{z} ) {r}_{z} {Z}_{r} + ( 1 - {b}_{z} ) {g}_{z} ( 1 - {r}_{z} ) {Z}_{g} + … + {b}_{z} {g}_{z} {r}_{z} {Z}_{sk}\end{matrix}$$

In above equation, X, Y, Z represents tristimulus values of color to be matched. X_{w}Y_{w}Z_{w}, XₖYₖZₖ represent measured tristimulus value of white dot and black dot on the monitor. XᵣYᵣZᵣ, X_{g}Y_{g}Z_{g}, X_{b}Y_{b}Z_{b} represent measured tristimulus value of primary color red, green and blue when dᵣ, d_{g}, d_{b} have their maximum values.

X_{c}, Y_{c}, Z_{c} are the tristimulus value of cyan driven by (G+B) when G and B choose the maximum value;

Xₘ, Yₘ, Zₘ are the tristimulus value of magenta driven by (R+B) when R and B choose the maximum value;

X_{y}, Y_{y}, Z_{y} are the tristimulus value of yellow driven by (R+G) when R and G choose the maximum value.

The variable parameters rₓ, r_{y}, r_{z}, gₓ, g_{y}, g_{z}, bₓ, b_{y}, b_{z} on right side of the equation are called channel primary value, they are used to map tristimulus value X, Y, Z on left side of the equation. From this point of view, channel primary value has channel independent property. The channel primary parameter is actually a function of primary parameter r, g and b instead of a simply variable.

The function is:

rₓ=r^{γ}^{ₓᵣ}, r_{y}=r^{γ}^{_{yr}}, r_{z}=r^{γ}^{_{zr}}; gₓ=g^{γ}^{_{xg}}, g_{y}=g^{γ}^{_{yg}}, g_{z}=g^{γ}^{_{zg}}; bₓ=b^{γ}^{_{xb}}, b_{y}=b^{γ}^{_{yb}}, b_{z}=b^{γ}^{_{zb}}

Please note the primary parameter r, g and b are the function of driving parameters dᵣ, d_{g}, d_{b}

The function is as follows:

r=dᵣ^{γ}^{_{rd}}, g=d_{g}^{γ}^{_{gd}}, b=d_{b}^{γ}^{_{bd}} the inverse solution is: dᵣ=r^{1/γ}^{_{rd}}, d_{g}=r^{1/γ}^{_{gd}}, d_{b}=r^{1/γ}^{_{bd}}

(4) Liu's normally-black-monitor color-matching equation based on additive color reproduction: In order to create profile for normally-blank-monitor and create the gray balance power function for normally-black TV monitor, the following Liu's normally-black additive color-matching equation based on additive method reproduction is used:

$$\{ \begin{matrix}X = \begin{matrix}( 1 - {r}_{x} ) ( 1 - {g}_{x} ) ( 1 - {b}_{x} ) {X}_{k} + {r}_{x} ( 1 - {g}_{x} ) ( 1 - {b}_{x} ) {X}_{r} + ( 1 - {r}_{x} ) {g}_{x} ( 1 - {b}_{x} ) {X}_{g} + ( 1 - {r}_{x} ) ( 1 - {g}_{x} ) {b}_{x} {X}_{b} + \\ ( 1 - {r}_{x} ) {g}_{x} {b}_{x} {X}_{c} + {r}_{x} ( 1 - {g}_{x} ) {b}_{x} {X}_{m} + {r}_{x} {g}_{x} ( 1 - {b}_{x} ) {X}_{y} + {r}_{x} {g}_{x} {b}_{x} {X}_{sw}\end{matrix} \\ Y = \begin{matrix}( 1 - {r}_{y} ) ( 1 - {g}_{y} ) ( 1 - {b}_{y} ) {Y}_{k} + {r}_{y} ( 1 - {g}_{y} ) ( 1 - {b}_{y} ) {Y}_{r} + ( 1 - {r}_{y} ) {g}_{y} ( 1 - {b}_{y} ) {Y}_{g} + ( 1 - {r}_{y} ) ( 1 - {g}_{y} ) {b}_{y} {Y}_{b} + \\ ( 1 - {r}_{y} ) {g}_{y} {b}_{y} {Y}_{c} + {r}_{y} ( 1 - {g}_{y} ) {b}_{y} {Y}_{m} + {r}_{y} {g}_{y} ( 1 - {b}_{y} ) {Y}_{y} + {r}_{y} {g}_{y} {b}_{y} {Y}_{sw}\end{matrix} \\ Z = \begin{matrix}( 1 - {r}_{z} ) ( 1 - {g}_{z} ) ( 1 - {b}_{z} ) {Z}_{k} + {r}_{z} ( 1 - {g}_{z} ) ( 1 - {b}_{z} ) {Z}_{r} + ( 1 - {r}_{z} ) {g}_{z} ( 1 - {b}_{z} ) {Z}_{g} + ( 1 - {r}_{z} ) ( 1 - {g}_{z} ) {b}_{z} {Z}_{b} + \\ ( 1 - {r}_{z} ) {g}_{z} {b}_{z} {Z}_{c} + {r}_{z} ( 1 - {g}_{z} ) {b}_{z} {Z}_{m} + {r}_{z} {g}_{z} ( 1 - {b}_{z} ) {Z}_{y} + {r}_{z} {g}_{z} {b}_{z} {Z}_{sw}\end{matrix}\end{matrix}$$

The normally-black-monitor color-matching equation in that invention is equivalent to the equation called gray calibration equation in patent PCT/2011/000327.

(5) Liu's RGB scan color-segmentation equation:

In order to create profile for scanner, we need to perform calibration calculation for scanner's gray balance function in RGB color space by using the following RGB scan color-segmentation equation; based on the RGB tristimulus value captured by CCD, RGB scan color-segmentation equation calculates the 3 primary' value (cyan, magenta, yellow) of scanned scale. In RGB scan color-segmentation equation, c′, m′, y′ are used to represent the primary parameter of color cyan, magenta and yellow. yₓ′, y_{y}′, y_{z}′, mₓ′, m_{y}′, m_{z}′, cₓ′, c_{y}′, c_{z}′ are used to represent channel primary values. In fact, difference between XYZ Liu's color-matching equation based on color subtraction method and RGB scan color-segmentation equation is similar to the difference between using kg or lb to weight same object. The equation uses different coordinate system to describe 3 primary colors (cyan, magenta, yellow) in RGB and XYZ color space. In order to differentiate primary values calculated in different color space, the primary value c, m, y calculated in XYZ color space is called scan primary value; the primary value c′, m′, y′ calculated in RGB color space is called twin scan primary value. Below is Liu's RGB scanning color-segmentation equation:

$$\{ \begin{matrix}R = \begin{matrix}( 1 - {y}_{x}^{′} ) ( 1 - {m}_{x}^{′} ) ( 1 - {c}_{x}^{′} ) {R}_{w} + ( 1 - {y}_{x}^{′} ) ( 1 - {m}_{x}^{′} ) {c}_{x}^{′} {R}_{c} + ( 1 - {y}_{x}^{′} ) {m}_{x}^{′} ( 1 - {c}_{x}^{′} ) {R}_{m} + {y}_{x}^{′} ( 1 - {m}_{x}^{′} ) ( 1 - {c}_{x}^{′} ) {R}_{y} + \\ {y}_{x}^{′} {m}_{x}^{′} ( 1 - {c}_{x}^{′} ) {R}_{r} + {y}_{x}^{′} ( 1 - {m}_{x}^{′} ) {c}_{x}^{′} {R}_{g} + ( 1 - {y}_{x}^{′} ) {m}_{x}^{′} {c}_{x}^{′} {R}_{b} + {y}_{x}^{′} {m}_{x}^{′} {c}_{x}^{′} {R}_{s}\end{matrix} \\ G = \begin{matrix}( 1 - {y}_{x}^{′} ) ( 1 - {m}_{x}^{′} ) ( 1 - {c}_{x}^{′} ) {G}_{w} + ( 1 - {y}_{x}^{′} ) ( 1 - {m}_{x}^{′} ) {c}_{x}^{′} {G}_{c} + ( 1 - {y}_{x}^{′} ) {m}_{x}^{′} ( 1 - {c}_{x}^{′} ) {G}_{m} + {y}_{x}^{′} ( 1 - {m}_{x}^{′} ) ( 1 - {c}_{x}^{′} ) {G}_{y} + \\ {y}_{x}^{′} {m}_{x}^{′} ( 1 - {c}_{x}^{′} ) {G}_{r} + {y}_{x}^{′} ( 1 - {m}_{x}^{′} ) {c}_{x}^{′} {G}_{g} + ( 1 - {y}_{x}^{′} ) {m}_{x}^{′} {c}_{x}^{′} {G}_{b} + {y}_{x}^{′} {m}_{x}^{′} {c}_{x}^{′} {G}_{s}\end{matrix} \\ B = \begin{matrix}( 1 - {y}_{x}^{′} ) ( 1 - {m}_{x}^{′} ) ( 1 - {c}_{x}^{′} ) {B}_{w} + ( 1 - {y}_{x}^{′} ) ( 1 - {m}_{x}^{′} ) {c}_{x}^{′} {B}_{c} + ( 1 - {y}_{x}^{′} ) {m}_{x}^{′} ( 1 - {c}_{x}^{′} ) {B}_{m} + {y}_{x}^{′} ( 1 - {m}_{x}^{′} ) ( 1 - {c}_{x}^{′} ) {B}_{y} + \\ {y}_{x}^{′} {m}_{x}^{′} ( 1 - {c}_{x}^{′} ) {B}_{r} + {y}_{x}^{′} ( 1 - {m}_{x}^{′} ) {c}_{x}^{′} {B}_{g} + ( 1 - {y}_{x}^{′} ) {m}_{x}^{′} {c}_{x}^{′} {B}_{b} + {y}_{x}^{′} {m}_{x}^{′} {c}_{x}^{′} {B}_{s}\end{matrix}\end{matrix}$$

Channel primary value in RGB scanning color-segmentation equation is function of reference primary value, and its format is same as XYZ scanning color-matching equation:

cₓ′=c′^{γ}^{_{xc′}}, c_{y}′=c′^{γ}^{_{yc′}}, c_{z}′=c′^{γ}^{_{zc′}}, mₓ′=m′^{γ}^{_{xm′}}, m_{y}′=m′^{γ}^{_{ym′}}, m_{z}′=m′^{γ}^{_{zm′}}, yₓ′=y′^{γ}^{_{xy′}}, y_{y}′=y′^{γ}^{_{yy′}}, y_{z}′=y′^{γ}^{_{zy′}}

The importance of Liu's color-matching equation in this gamut mapping method:

When creating the profile for scanner, printer or monitor to achieve the gray balance target, Liu's color-matching equation is used to perform characteristic calibration for the related gray balance function and obtain the coefficient value in gray balance function which will be referenced in the profile. Because iteration method is used to solve the Liu's color-matching equation and the result is accurate; it is very suitable to perform calibration calculation on gray balance polynomial or power function using Liu's color-matching equation. It also makes it possible to quickly perform color gamut mapping calculation using Liu's color gamut mapping equation.

4. A method to characterizing Liu's color-matching equation

Objective of characterization:

After observing the channel primary function in Liu's color-matching equation, we found channel primary value is the power function of reference primary value, the constant coefficient in polynomial can be calculated with characterization process;

Procedure: for the 4 types of Liu's color-matching equations mentioned above, the characterization procedure is the same:

(1) In order to obtain the tristimulus value of three primary scales, the XYZ and RGB tristimulus value of sample color on the color gamut scale needs to be measured. If subscript o, p, q_{w}, qₖ are used to differentiate the related reference data of scanner, printer, normally-white computer monitor and normally-black TV monitor. the 15 tristimulus value arrays can be represented as follows:
2 pairs of scanner tristimulus value: [X_{oci}, Y_{oci}, Z_{oci}], [Xₒₘᵢ, Yₒₘᵢ, Zₒₘᵢ], [X_{oyi}, Y_{oyi}, Z_{oyi}] and [R_{oci}, G_{oci}, B_{oci}], [Rₒₘᵢ, Gₒₘᵢ, Bₒₘᵢ], [R_{oyi}, G_{oyi}, B_{oyi}]
printer's tristimulus value: [X_{pci}, Y_{pci}, Z_{pci}], [Xₚₘᵢ, Yₚₘᵢ, Zₚₘᵢ], [X_{pyi}, Y_{pyi}, Z_{pyi}]
tristimulus value of normally-white-monitor (computer): [X_{qwri}, Y_{qwri}, Z_{qwri}], [X_{qwgi}, Y_{qwgi}, Z_{qwgi}], [X_{qwbi}, Y_{qwbi}, Z_{qwbi}]
tristimulus value for normally-black-monitor (television): [X_{qkri}, Y_{qkri}, Z_{qkri}], [X_{qkgi}, Y_{qkgi}, Z_{qkgi}], [X_{qkbi}, Y_{qkbi}, Z_{qkbi}]

(2) Calculate the clamping luminance value [Y_{toci}, Yₜₒₘᵢ, Y_{toyi}], [G_{toci}, Gₜₒₘᵢ, G_{toyi}], [Y_{tpci}, Yₜₚₘᵢ, Y_{tpyi}], [Y_{tqwri}, Y_{tqwgi}, Y_{tqwbi}], [Y_{tqkri}, Y_{tqkgi}, Y_{tqkbi}] for scanner, printer, normally-white computer monitor and normally-black TV monitor using primary clamping luminance model based on the above 15 sets of tristitulus arrays;

(3) Plug clamping luminance value into reference primary formula to calculate reference primary value:

$$\begin{matrix}{c}_{oi} = \frac{{Y}_{w} - {Y}_{toci}}{{Y}_{w} - {Y}_{c}} , & {m}_{oi} = \frac{{Y}_{w} - {Y}_{tomi}}{{Y}_{w} - {Y}_{m}} , & {y}_{oi} = \frac{{Y}_{w} - {Y}_{toyi}}{{Y}_{w} - {Y}_{y}}\end{matrix}$$

$$\begin{matrix}{c}_{oi}^{′} = \frac{{G}_{w} - {G}_{toci}}{{G}_{w} - {G}_{c}} , & {m}_{oi}^{′} = \frac{{G}_{w} - {G}_{tomi}}{{G}_{w} - {G}_{m}} , & {y}_{oi}^{′} = \frac{{G}_{w} - {G}_{toyi}}{{G}_{w} - {G}_{y}}\end{matrix}$$

$$\begin{matrix}{c}_{pi} = \frac{{Y}_{w} - {Y}_{tpci}}{{Y}_{w} - {Y}_{c}} , & {m}_{pi} = \frac{{Y}_{w} - {Y}_{tpmi}}{{Y}_{w} - {Y}_{m}} , & {y}_{pi} = \frac{{Y}_{w} - {Y}_{tpyi}}{{Y}_{w} - {Y}_{y}} ,\end{matrix} \qquad {k}_{pi} = \frac{{Y}_{w} - {Y}_{tki}}{{Y}_{w} - {Y}_{t}}$$

$$\begin{matrix}{r}_{qwi} = \frac{{Y}_{w} - {Y}_{tqwri}}{{Y}_{w} - {Y}_{r}} , & {g}_{qwi} = \frac{{Y}_{w} - {Y}_{tqwgi}}{{Y}_{w} - {Y}_{g}} , & {b}_{qwi} = \frac{{Y}_{w} - {Y}_{tqwbi}}{{Y}_{w} - {Y}_{b}}\end{matrix}$$

$$\begin{matrix}{r}_{qki} = \frac{{Y}_{tqkri} - {Y}_{k}}{{Y}_{r} - {Y}_{k}} , & {g}_{qki} = \frac{{Y}_{tqkgi} - {Y}_{k}}{{Y}_{g} - {Y}_{k}} , & {b}_{qki} = \frac{{Y}_{tqkbi} - {Y}_{k}}{{Y}_{b} - {Y}_{k}}\end{matrix}$$

(4) Use following model to calculate channel primary value for Liu's subtractive color-matching equation, Liu's 4-primary color-matching equation and monitor color-matching equation:

cₓᵢ, c_{yi}, c_{zi:} cₓ=(X_{w}−X)/(X_{w}−X_{c}), c_{y}=(Y_{w}−Y)/(Y_{w}−Y_{c}), c_{z}=(Z_{w}−Z)/(Z_{w}−Z_{c})

cₓ, c_{y}, c_{z} represent channel primary value of cyan ink in X, Y, Z channel, with cₓ, c_{y}, c_{z} we can get channel primary array [cₓᵢ, c_{yi}, c_{zi}]. As for cyan and yellow, we can simply substitute the letter c to letter m or y in the above formula respectively to get the corresponding primary value array [mₓᵢ, m_{yi}, m_{zi}] and [Yₓᵢ, Y_{yi}, y_{zi}];

(5) Use following model to calculate channel primary value cₓᵢ′, c_{yi}′, c_{zi}′ in RGB scan color-segmentation equation:

cₓ′=(R_{w}−R)/(R_{w}−R_{c}), c_{y}′=(G_{w}−G)/(G_{w}−G_{c}), c_{z}′=(B_{w}−B)/(B_{w}−B_{c})

cᵣ′, c_{g}′, c_{b}′ represent the channel primary value of cyan ink in R, G, B channel, with cᵣ′, c_{g}′, c_{b}′ we can get channel primary array [cₓᵢ, c_{yi}, c_{zi}]. As for cyan and yellow, we can simply substitute letter c with m or y in above formula respectively to get primary value array [mᵣᵢ′, m_{gi}′, m_{bi}′] and [yᵣᵢ′, y_{gi}′, y_{bi}′];

(6) Use following model to calculate channel primary value rₓⱼ, g_{yj}, b_{zj} in normally-white-monitor color-matching equation:

rₓ=(X_{w}−X)/(X_{w}−Xᵣ), r_{y}=(Y_{w}−Y)/(Y_{w}−Yᵣ), r_{z}=(Z_{w}−Z)/(Z_{w}−Zᵣ)

rₓ, r_{y}, r_{z} represent the channel primary value of red in X, Y, Z channel. As for primary green or blue, we can simply substitute the letter r to letter g or b in the above formula respectively to get the primary value array [gₓⱼ, g_{yj}, g_{zj}] and [bₓⱼ, b_{yj}, b_{zj}];

(7) Use following model to calculate channel primary value rₓⱼ, g_{yj}, b_{zj} in normally-black-monitor color-matching equation:

rₓ=(X−Xₖ)/(Xᵣ−Xₖ), r_{y}=(Y−Yₖ)/(Yᵣ−Yₖ), r_{z}=(Z−Zₖ)/(Zᵣ−Zₖ)

rₓ, r_{y}, r_{z} represent the channel primary value of red in X, Y, Z channel. As for primary green or blue, we can simply substitute the letter r to letter g or b in the above formula respectively to get the primary value array [gₓⱼ, g_{yj}, g_{zj}] and [bₓⱼ, b_{yj}, b_{zj}];

(8) Use curve fitting method to generate channel primary function for Liu' subtractive color-matching equation which is in accordance with subtractive color reproduction method and used for printer and scanner: perform curve fitting on primary cyan's reference primary value array cᵢ and corresponding channel dot area ratio array cₓᵢ, c_{yi}, c_{zi}, and the result is function expression of channel primary value; as to primary cyan, we can get following channel primary value function model:

cₓ=c^{γ}^{_{xc}}, c_{y}=c^{γ}^{_{yc}}, c_{z}=c^{γ}^{_{zc}}

As for primary magenta, we only need to substitute c with m in above equations; as for primary yellow, we only need to substitute c with y in above equations.

(9) Use curve fitting method to generate channel primary function for normally-white-monitor color-matching equation: perform curve fitting to primary red's reference primary value array rⱼ and corresponding channel primary value array rₓⱼ, r_{yj}, r_{zj}, and the result is function expression of channel primary value; as to primary red, we can get following channel primary function:

rₓ=r^{γ}^{ₓᵣ}, r_{y}=r^{γ}^{_{yr}}, r_{z}=r^{γ}^{_{zr}}

As for primary green's channel primary value function, we only need to substitute r with g in above equations; as for primary blue's channel primary value function, we only need to substitute r with g in above equations;

(10) Use curve fitting method to generate channel primary function for digital camera or television camera color-matching equation: (as to generate channel primary value function for normally-black-monitor, please refer to patent specification PCT/2011/000327). Perform curve fitting on primary red's reference primary value array rⱼ and corresponding channel primary value arrays rₓⱼ, r_{yj}, r_{zj} respectively, and the result is function expression of channel primary value; as to primary red, we can have following channel primary function:

rₓ=r^{γ}^{ₓᵣ}, r_{y}=r^{γ}^{_{yr}}, r_{z}=r^{γ}^{_{zr}}

As for primary green's channel primary value function, we only need to substitute r with g in above equations; as for primary blue's channel primary value function, we only need to substitute r with g in above equations;

The above curve fitting steps work out all coefficients in channels polynomial and the characterization process is completed.

5. A method to generate pure gray scale for scanner, printer, normally-white-monitor, and normally-black-monitor

Objective: quality of gray tone reproduction is prime quality index of color image reproduction; this invention has follows important measure: generate pure ideal gray scale tristimulus value for scanner, printer or monitor respectively, and use it as base of image gray component reproduction. Pure gray scale means the gray tristimulus value of the scale is free of ‘red shift’ component.

Procedure:

(1) Create pure gray scale for scanner, printer and monitor: on the scanner or printer's color target and scale sample color displayed on the monitor, measure the luminance of compound color to get the initial luminance array [Yₒₐᵢ], [G_{o′ai}], [Yₚₐᵢ], [Y_{qwai}], [Y_{qkai}], they are not pure luminance value.

(2) Convert the initial luminance array [Yₒₐᵢ], [G_{o′ai}], [Yₚₐᵢ], [Y_{qwai}], [Y_{qkai}] to initial density array [Dₒₐᵢ], [D_{o′ai}], [Dₚₐᵢ], [D_{qwai}], [D_{qkai}] as follows:
[Dₒₐᵢ]=lg(Y_{ow}/Yₒₐᵢ), [D_{o′ai}]=lg(G_{ow}/G_{o′ai}), [Dₚₐᵢ]=lg(Y_{pw}/Yₚₐᵢ), [D_{qwai}]=lg(Y_{wq}/Y_{pwai}),

(3) Normalize the initial density array [Dₒₐᵢ], [D_{o′ai}], [Dₚₐᵢ], [D_{qwai}], [D_{qkai}] to get normalized density array [D_{obi}], [D_{o′bi}], [D_{pbi}], [D_{qwbi}], [D_{qkbi}] as follows:
[D_{o′bi}]=[D_{o′ai}]/D_{o′amax}, [D_{pbi}]=[Dₚₐᵢ]/Dₚₐₘₐₓ, [D_{qwbi}]=[D_{qwai}]/D_{qwamax}, [D_{qkbi}]=[D_{qkai}]/D_{qkamax},

In above, Dₒₐₘₐₓ, D_{o′amax}, Dₚₐₘₐₓ, D_{qwamax}, D_{qkamax} are the maximum values in array [Dₒₐᵢ], [D_{o′ai}], [Dₚₐᵢ], [D_{qwai}], [D_{qkai}].

(4) Normalize the primary scale's driving value to get the normalized driving array [dᵢ]. Letter d represents the parameter of scale driving value. It represents both the driving parameter CMYK and the input value of driving parameter RGB.

(5) Use normalized driving array [dᵢ] as independent variable array and normalized initial density array [D_{obi}], [D_{o′bi}], [D_{pbi}], [D_{qwbi}], [D_{qkbi}] as dependent variable respectively to perform power function fitting and get the gray scale's normalized initial density model as follows:

D_{ob}=d̂γₒ, D_{o′b}=d̂γ_{o′}, D_{pb}=d̂γₚ, D_{qwb}=d̂γ_{qw}, D_{qkb}=d̂γ_{qk}

(6) Denormalize D_{ob}, D_{o′b}, D_{pb}, D_{qb}, D_{qb} respectively to get denormalized initial density array Dₒ, D_{o′}, Dₚ, D_{qw}, D_{qk} as follows:

[Dₒᵢ]=[dₒᵢ]̂γₒ×Dₒₐₘₐₓ, [D_{o′}]=[dₒᵢ]̂γ_{o′}×D_{o′amax}, [Dₚᵢ]=[dₒᵢ]̂γₚ×Dₚₐₘₐₓ, [D_{qwi}]=[dₒᵢ]̂γ_{qw}×D_{qwamax}, [D_{qki}]=[dₒᵢ]̂γ_{qk}×D_{qkamax}

Please note although Dₒ, D_{o′}, Dₚ, D_{qw}, D_{qk} are called denormolized initial density array, their values don't equal to initial density array [Dₒₐᵢ], [D_{o′ai}], [Dₚₐᵢ], [D_{qwi}], [D_{qki}]. The purpose of proforming data fitting as above is to optimize the initial density array. Dₒ, D_{o′}, Dₚ, D_{qw}, D_{qk} are the pure gray tone density of scanner, printer, normally-white-monitor and normally-black-monitor we are looking for. Let gray tone of color target scale=i, the pure gray density array of scanner, printer, normally-white and normally-black-monitor are [Dₒᵢ], [D_{o′i}], [Dₚᵢ], [D_{qwi}], [D_{qki}].

(7) Create ideal gray luminance array for scanner, printer, normally-white-monitor and normally-black-monitor [Yₒᵢ], [Gₒᵢ], [Yₚᵢ], [Y_{qwi}], [Y_{qki}], i.e.
let [Yₒᵢ]=Y_{wo}/(10̂Dₒᵢ), [Gₒᵢ]=G_{wo}/(10̂D_{o′i}), [Yₚᵢ]=Y_{wp}/(10̂Dₚᵢ), [Y_{qwi}]=Y_{ww}/(10̂D_{qwi}), [Y_{qki}]=Y_{wk}/(10̂D_{qki})

(8) Calculate chromaticity coordinates of reference white dot for scanner, printer and monitor:

Let the white color's tristimulus value on scanner color target X_{ow}, Y_{ow}, Z_{ow} be the white dot's tristimulus value in XYZ color space.

Let the white color's tristimulus value on scanner color target R_{ow}, G_{ow}, B_{ow} be the white dot's tristimulus value in RGB color space.

Let white color's tristimulus value on printer color target X_{pw}, Y_{pw}, Z_{pw} be the white dot's tristimulus value in XYZ color space.

Let chromaticity coordinates of D65 illuminant be the reference white dot's tristimulus value on monitor to get R_{ow}G_{ow}B_{ow}. Given o, p, q as the sub coordinator of scanner, printer and monitor, the chromaticity coordinates of reference white dot can be calculated as follows:

x_{ow}=X_{ow}/(X_{ow}+Y_{ow}+Z_{ow}), y_{ow}=Y_{ow}/(X_{ow}+Y_{ow}+Z_{ow})

r_{ow}=R_{ow}/(R_{ow}+G_{ow}+B_{ow}), g_{ow}=G_{ow}/(R_{ow}+G_{ow}+B_{ow})

x_{pw}=X_{pw}/(X_{pw}+Y_{pw}+Z_{pw}), y_{pw}=Y_{pw}/(X_{pw}+Y_{pw}+Z_{pw})

x_{qw}=x_{qk}=0.3127, y_{qw}=x_{qk}=0.3290

(9) Using pure gray luminance array [Yₒᵢ], [Gₒᵢ], [Yₚᵢ], [Y_{qwi}], [Y_{qki}] from 7^{th} step above and chromaticity coordinates x_{ow}, y_{ow}, r_{ow}, g_{ow}, x_{pw}, y_{pw}, x_{qw}, y_{qw}, x_{qk}, y_{qk} to create pure gray scale for scanner, printer, normally-white-monitor and normally-black-monitor respectively; each pure gray scale's tristimulus value is calculated as follows:

$$Scanner {X}_{oi} = \frac{{x}_{ow}}{{y}_{ow}} \cdot {Y}_{oi} , \qquad {Y}_{oi} = {Y}_{oi} , \qquad {Z}_{oi} = \frac{( 1 - {x}_{ow} - {y}_{ow} )}{{y}_{ow}} \cdot {Y}_{oi}$$

$${R}_{oi} = ( {r}_{ow} / {g}_{ow} ) \cdot {G}_{oi} , \qquad {G}_{oi} = {G}_{oi} , \qquad {B}_{oi} = ( 1 - {r}_{ow} - {g}_{ow} ) \cdot {G}_{oi}$$

$$Printer {X}_{pi} = \frac{{x}_{pw}}{{y}_{pw}} \cdot {Y}_{pi} , \qquad {Y}_{pi} = {Y}_{pi} , \qquad {Z}_{pi} = \frac{( 1 - {x}_{pw} - {y}_{pw} )}{{y}_{pw}} \cdot {Y}_{pi}$$

$$Normally \text{-} white \text{-} monitor {X}_{qwi} = \frac{{x}_{qw}}{{y}_{qw}} \cdot {Y}_{qwi} , \qquad {Y}_{qwi} = {Y}_{qwi} ,$$

$${Z}_{qwi} = \frac{( 1 - {x}_{qw} - {y}_{qw} )}{{y}_{qw}} \cdot {Y}_{qwi}$$

$$Normally \text{-} b lack \text{-} monitor {X}_{qki} = \frac{{x}_{qk}}{{y}_{qk}} \cdot {Y}_{qki} , \qquad {Y}_{qki} = {Y}_{qki} ,$$

$${Z}_{qki} = \frac{( 1 - {x}_{qk} - {y}_{qk} )}{{y}_{qk}} \cdot {Y}_{qki}$$

6. A method to characterize component primary values of pure gray scale

Objective: The objective of using Liu's color-matching equation to characterize Liu's pure gray scale is to calculate pure gray scale's component primary value and then present it as function of pure gray density parameter. Gray balance is a critical index to the quality of color image reproduction. The primary function expression at gray balance status can be used to derive any color's gray core component; gray core can be viewed from following respect: a color is mixed with primary c, m, y, the amount of these three primary are unequal value, and the primary color with least reference primary value is gray core of this color's gray component; gray core is the least value of 3 primary, together with other 2 primary, gray core of a composite color is produced. With the help of gray core concept, this invention achieved the objective to segment a color into 3 primary colors rapidly and accurately, and reproduce gray component with priority.

Procedure:

(1) In scanner's RGB color space, create gray balance power function c′ (D_{rgb}), g′ (D_{rgb}), b′ (D_{rgb}) for scanner. The steps are: perform color-matching calculation for scanner's gray scale array [Rₒᵢ,Gₒᵢ,Bₒᵢ] using RGB scan color-segmentation equation; the result is scanner gray scale's reference primary value array [cᵢ′, mᵢ′, yᵢ′], then calculate gray scale's density array [D_{rgb}] with gray scale luminance array [Gₒᵢ]: plug luminance array [Gₒᵢ] into density formula D_{rgb}=lg(G_{ow}/Gₒᵢ) and get density array [D_{rgbi}]; finally perform data fitting with [D_{rgb}] as independent variable and twin primary values [c′ᵢ, m′ᵢ, y′ᵢ] as dependent variables respectively, and the result is scanner's gray balance power function as follows:

c_{dd}′=D_{rgb}^{γ}^{_{co′}}, m_{dd}′=D_{rgb}^{γ}^{_{mo′}}, y_{dd}′=D_{rgb}^{γ}^{_{yo′}}

In following scanner color-segmentation equation, twin primary values c_{dd}′, m_{dd}′, y_{dd}′ will be used as gray core.

(2) Create c′m′y′-cmy power function for scanner, with which primary value c′, m′, y′ can be converted to primary value c, m, y; the method is: perform color-matching calculation for array [Xₒᵢ, Yₒᵢ, Zₒᵢ] with Liu's subtractive color-matching equation, and get scanner's reference primary array [cᵢ, mᵢ, yᵢ] which forms gray scale in CMY color space, then perform curve fitting with [cᵢ′], [mᵢ′], [yᵢ′] as independent variables and [cᵢ], [mᵢ], [yᵢ] as dependent variable, and result is power function conversion expression for c′m′y′-cmy:

c=c′^{γ}^{_{cc′}}, m=m′^{γ}^{_{mm′}}, y=y′^{γ}^{_{yy′}}

(3) Create gray balance primary power function for computer's normally-white-monitor and television's normally-black-monitor: there is only one slight difference between color-matching equations of computer's normally-white-monitor and television's normally-black-monitor. We use superscript w and subscript k to denote two cases: perform color-matching calculation for gray scale array [X_{qwi}, Y_{qwi}, Z_{qwi}] and [X_{qki}, Y_{qki}, Z_{qki}] using normally-white-monitor color-matching equation and normally-black-monitor color-matching equation, and we get gray scale's primary value array [r_{qwi}, g_{qwi}, b_{qwi}], [r_{qki}, g_{qki}, b_{qki}]; then perform curve fitting with pure gray density arrays [D_{qwi}], [D_{qki}] as independent variables and [r_{qwi}, g_{qwi}, b_{qwi}], [r_{qki}, g_{qki}, b_{qki}] as dependent variables respectively to get the gray balance primary function for normally-white-monitor and normally-black-monitor:

r_{qw}=D_{qw}^{γ}^{_{rN}}, g_{qw}=D_{qw}^{γ}^{_{gw}}, b_{qw}=D_{ow}^{γ}^{_{bw}}

r_{qk}=D_{qk}^{γ}^{ᵣₖ}, g_{qk}=D_{qk}^{γ}^{_{gk}}, b_{qk}=Dₒₖ^{γ}^{_{bk}}

Inverse functions of above are:

D_{qw}=r_{qw}^{1/γ}^{_{rw}}, D_{qw}=g_{qw}^{1/γ}^{_{gw}}, D_{ow}=b_{qw}^{1/γ}^{_{bw}}

D_{qk}=r_{qk}^{1/γ}^{ᵣₖ}, D_{qk}=g_{qk}^{1/γ}^{_{gk}}, Dₒₖ=b_{qk}^{1/γ}^{_{bk}}

r_{qw}, g_{qw}, b_{qw}, r_{qk}, g_{qk}, b_{qk} are component primary value calculated based on pure neutral gray color; to emphasize this special property, we call both r_{qw}, g_{qw}, b_{qw} and r_{qk}, g_{qk}, b_{qk} gray balance primary values; one of them will be used as gray core of chromatic color. In other words, amongst 3 component primary values of ideal gray color, only the component primary used as gray core can be called gray core.

(4) Create gray balance power function for 3 primary color printer:

Perform color-matching calculation for gray scale array [Xₚᵢ, Yₚᵢ, Zₚᵢ] with Liu's 3 primary color-matching equation, and the result is gray scale's primary array [cₚᵢ, mₚᵢ, yₚᵢ]; then perform curve fitting with pure gray density array [Dₚᵢ] as independent variable and [cₚᵢ, mₚᵢ, yₚᵢ] as dependent variable, thus we get power function of 3 primary printer gray balance primary value as follows:

cₚ=Dₚ^{γ}^{_{cd}}, mₚ=Dₚ^{γ}^{_{md}}, yₚ=Dₚ^{γ}^{_{yd}}

Inverse functions of above are:

Dₚ=cₚ^{1/γ}^{_{cd}}, Dₚ=mₚ^{1/γ}^{_{md}}, Dₚ=yₚ^{1/γ}^{_{yd}}

Above gray balance power function is called 3 primary printer gray balance power function. cₚ, mₚ, yₚ is component primary value based on pure neutral gray [Xₚᵢ, Yₚᵢ, Zₚᵢ]; cₚ, mₚ, yₚ calculated with Liu' subtractive color-matching equation is not used as ‘gray core’, but for calculating cmy's driving value in Liu's 4 primary mapping equation. In this invention, 4 primary color printer's pure neutral gray is [Xₚᵢ, Yₚᵢ, Zₚᵢ] as well, while component primary value of [Xₚᵢ, Yₚᵢ, Zₚᵢ] also includes gray substitution parameter kₚ.

(5) Create gray balance polynomial for 4-primary color printer (or 4 primary color press):

a. Determine gray component substitute value: measure black ink printing scale on color target, record tristimulus value of sample color; calculate black primary's clamping luminance array [Yₜₖᵢ] with clamping luminance equation; then calculate black primary's reference primary array kᵢ based on black primary's clamping luminance Yₜₖᵢ:

kᵢ=(Y_{wp}−Yₜₖᵢ)/(Y_{wp}−Yₛₖ)

b. Perform curve fitting with normalized driving array [dₖᵢ] as independent array and [kᵢ] as dependent array and the result is: k=dₖ̂γₖ

c. Gray substitute value is denoted as k_{dd}, let k_{dd}=Q(dₖ̂γₖ)ⁿ; Q is a pre-set proportion constant value for controlling maximum black print value; n is a index value based on tone length of black print. n can be used to easily adjust tone of black print. Please note, gray substitute value kₚ is purified black component and is called pure gray component substitute value;

d. Solve pure gray's primary value array [cᵢ], [mᵢ], [yᵢ]. As to pure gray scale, there are i sets of tristimulus value [Xₚᵢ, Yₚᵢ, Zₚᵢ]; if each set of tristimulus value is plug in left side of 4 primary color matching equation one by one, and at same time corresponding [kₚᵢ] is plug into same equation, then 4 primary color-matching equation turns into a static Liu's color-matching equation with only c, m, y as its variables; meanwhile solve equation using iteration method to get reference primary array [cᵢ], [mᵢ], [yᵢ];

e. Preform curve fitting with [Dₚᵢ] as independent variable and [cₚᵢ], [mₚᵢ], [yₚᵢ], [kₚᵢ] as dependent variables, and results are gray balance polynomial for 4 primary color printing, primary value cₚ, mₚ, yₚ and gray component substitute value kₚ as follows:

cₚ=a₀+a₁Dₚ+a₂Dₚ²+a₃Dₚ³+ . . . , mₚ=b₀+b₁Dₚ+b₂Dₚ²+b₃Dₚ³+ . . .

yₚ=c₀+c₁Dₚ+c₂Dₚ²+c₃Dₚ³+ . . . , kₚ=d₀+d₁Dₚ+d₂Dₚ²+d₃Dₚ³+ . . .

cₚ, mₚ, yₚ calculated from above function are component primary values calculated based on visual neutral gray under gray balance condition; to emphasize this special feature, we call cₚ, mₚ, yₚ gray balance primary value in printing color space. In printing color space, amongst cₚ, mₚ, yₚ, there must be a gray balance primary value, together with kₚ, to form gray core which conform to visual effect, and this gray balance primary value is called gray core.

7. A method to perform Gamma correction for gray tone of image

Objective: because image reproduction media and device tend to dull the tone of display and printing image, we have to do overall Gamma correction to image tone. Gamma correction method adopted by this invention is totally different from conventionally technology and ensures Gamma correction and gamut mapping can be carried out at same phase.

Procedure:

(1) Express pure gray density parameter as function of driving parameter: [Dₚᵢ], [D_{qwi}], [D_{qki}] are pure gray density arrays of printer, normally-black-monitor and normally-black-monitor mentioned in article 5 section (6); normalize [Dₚᵢ], [D_{qwi}], [D_{qki}] and the results are still denoted as [Dₚᵢ], [D_{qwi}], [D_{qki}]; then we express them as function of normalized driving parameter [dᵢ]: perform curve fitting with [dᵢ] as independent variable and [Dₚᵢ], [D_{qwi}], [D_{qki}] as dependent variables, the result is power function expression of pure gray density:

Dₚ=d^{γ}^{ₚ}, D_{qw}=d^{γ}^{_{qw}}, D_{qk}=d^{γ}^{_{qk}}

(2) Express Gamma correction density as function of pure gray density, i.e. express corrected density Dₚ′, D_{qw}′, D_{qk}′ as function of original density Dₚ, D_{qw}, D_{qk}:

Dₚ′=dₚ^{1/γ}^{ₚ}=Dₚ^{1/γ}^{ₚ}^{²}, D_{qw}′=d_{qw}^{1/γ}^{_{qw}}=D_{qw}^{1/γ}^{_{qw}}^{²}, D_{qk}′=dₖ^{1/γ}^{_{qk}}=D_{qk}^{1/γ}^{_{qk}}^{²}

Above three makes up Liu's Gamma correction equations for Gamma correction density calculation.

8. A method to create Dₗxₗyₗ profile connection color space for scanner in XYZ color space

Objective: color input devices such as digital camera and scanner need to transfer captured color information to color output devices such as monitor and printer. Existing methods use CIE LAB (CIECAM02) as PCS profile connection space; it is correct to use uniform color space as link, however, such uniform color space is not ideally uniform; therefore using it as PCS profile connection space leads to obvious color conversion error and involves tedious steps. The other problem is related to color value transfer method. Cross-media color transmission over long distance is very common today, mobile communication, digital television, and ground-to-air image communication broke the pattern of color management limitation on ‘one time one location’. Traditional method to generate luminance signal and color difference signals cannot meet constant luminance principle in non-lineal condition, which worsens reproduction quality of television image details. To solve this problem, this invention offers a brand new, multi-functional Dₗxₗyₗ profile connection space; the method to create Dₗxₗyₗ profile connection color space in XYZ space is explained as below.

Procedure: Dₗxₗyₗ color space is created using Liu's color-segmentation equation. The equation is based on following theory: a color is generated in accordance with 3 primary color composition theory; while from a new respective, we can suppose: a color is always composed of two components: one is gray component and its percentage is p, the other is secondary color component composed of 2 primary colors and its percentage is (1−p), so the new structure is [1 visual gray component+2 primary components]. Both perspectives are equal. The new one seems more complex in the first place; however such complexity brings us many benefits, such as turning high order algorithm into simple analytic algorithm thus enhancing computing efficiency. Liu's color-segmentation equation has 2 sub-types: the one for scanner is called Liu's scanning color-segmentation equation; the one for digital camera, digital video camera and television camera is called Liu's photographed color-segmentation equation.

As color obtained by scanner usually is transformed to gamut of printing device, Liu's color-segmentation equation based on subtractive color-reproduction is chosen;

As color obtained by digital camera usually is transformed to normally-white-monitor, Liu's color-segmentation equation based on normally-white-monitor color-matching equation is chosen;

As color obtained by television camera is usually transformed to normally-black-monitor, Liu's color-segmentation equation based on normally-black-monitor color-matching equation is chosen; each Liu's color-segmentation equation has 3 sub-types.

(1) A method to create Dₗxₗyₗ profile connection color space for scanner in XYZ color space

Step 1, Create Liu's color-segmentation equation for scanner:

Format of Liu's color-segmentation equation for scanner: 3 sub-types are as follows:

$$\{ \begin{matrix}X = [ \begin{matrix}( 1 - c ) ( 1 - m ) {X}_{w} + c ( 1 - m ) {X}_{c} + \\ ( 1 - c ) m {X}_{m} + {cmX}_{b}\end{matrix} ] \cdot ( 1 - p ) + p \cdot {X}_{sk} \\ Y = [ \begin{matrix}( 1 - c ) ( 1 - m ) {Y}_{w} + c ( 1 - m ) {Y}_{c} + \\ ( 1 - c ) m {Y}_{m} + {cmY}_{b}\end{matrix} ] \cdot ( 1 - p ) + p \cdot {Y}_{sk} \\ Z = [ \begin{matrix}( 1 - c ) ( 1 - m ) {Z}_{w} + c ( 1 - m ) {Z}_{c} + \\ ( 1 - c ) m {Z}_{m} + {cmZ}_{b}\end{matrix} ] \cdot ( 1 - p ) + p \cdot {Z}_{sk}\end{matrix} \\ \{ \begin{matrix}X = [ \begin{matrix}( 1 - c ) ( 1 - y ) {X}_{w} + c ( 1 - y ) {X}_{c} + \\ ( 1 - c ) y {X}_{y} + {cyX}_{g}\end{matrix} ] \cdot ( 1 - p ) + p \cdot {X}_{sk} \\ Y = [ \begin{matrix}( 1 - c ) ( 1 - y ) {Y}_{w} + c ( 1 - y ) {Y}_{c} + \\ ( 1 - c ) y {Y}_{y} + {cyY}_{g}\end{matrix} ] \cdot ( 1 - p ) + p \cdot {Y}_{sk} \\ Z = [ \begin{matrix}( 1 - c ) ( 1 - y ) {Z}_{w} + c ( 1 - y ) {Z}_{c} + \\ ( 1 - c ) y {Z}_{y} + {cyZ}_{g}\end{matrix} ] \cdot ( 1 - p ) + p \cdot {Z}_{sk}\end{matrix} \\ \{ \begin{matrix}X = [ \begin{matrix}( 1 - c ) ( 1 - y ) {X}_{w} + m ( 1 - y ) {X}_{m} + \\ ( 1 - m ) y {X}_{y} + {myX}_{r}\end{matrix} ] \cdot ( 1 - p ) + p \cdot {X}_{sk} \\ Y = [ \begin{matrix}( 1 - c ) ( 1 - y ) {Y}_{w} + m ( 1 - y ) {Y}_{m} + \\ ( 1 - m ) y {Y}_{y} + {myY}_{r}\end{matrix} ] \cdot ( 1 - p ) + p \cdot {Y}_{sk} \\ Z = [ \begin{matrix}( 1 - c ) ( 1 - y ) {Z}_{w} + m ( 1 - y ) {Z}_{m} + \\ ( 1 - m ) y {Z}_{y} + {myZ}_{r}\end{matrix} ] \cdot ( 1 - p ) + p \cdot {Z}_{sk}\end{matrix}$$

Liu's color-segmentation equation is a set of equations comprising 3 basic equations; the difference amongst them is:

One is color-segmentation equation with [1 primary cyan+1 primary magenta+visual gray]

One is color-segmentation equation with [1 primary cyan+1 primary yellow+visual gray]

One is color-segmentation equation with [1 primary magenta+1 primary yellow+visual gray]

Simply put, we can call them color-segmentation equation CMK, color-segmentation equation CYK and color-segmentation equation MYK. Three equations seem complex, but they are actually simply quadratic equations and can be solved rapidly with simple analytic method.

In above equations, X, Y, Z are tristimulus values obtained by scanner,

X_{w}, Y_{w}, Z_{w} are tristimuls of solid white measured from scanner target,

X_{c}, Y_{c}, Z_{c} are tristimuls of solid cyan,

Xₘ, Yₘ, Zₘ are tristimuls of solid magenta,

X_{y}, Y_{y}, Z_{y} are tristimuls of solid yellow,

Xₛₖ, Yₛₖ, Zₛₖ are tristimuls values of black dot composed of solid cyan, solid magenta and solid yellow, and have same chromaticity coordinates as X_{w}, Y_{w}, Z_{w}.

With help of computer program, we can choose one of three color-segmentation equations to perform color-segmentation and get gray value p in XYZ.

In Liu's color-segmentation equation, let the value in square brackets on right side equal to sold white color's tristimulus value X_{w}, Y_{w}, Z_{w} measured on scanner color target, then the equation turns into its gray scale format as follows:

Xᵥ=X_{w}(1−p)+pXₛₖ

Yᵥ=Y_{w}(1−p)+pYₛₖ

Zᵥ=Z_{w}(1−p)+pZₛₖ

If we plug [pᵢ] into left side of gray scale format of Liu's color-segmentation equation respectively, the resulted tristimulus value [Rᵥᵢ, Gᵥᵢ, Bᵥᵢ] is equal to tristimulus value [Rₒᵢ, Gₒᵢ, Bₒᵢ] of pure gray scale.

Step 2, Create Dₗxₗyₗ profile connection color space using above concept:

(a) Calculate chromaticity coordinates of color XᵥYᵥZᵥ based on value XᵥYᵥZᵥ on left side of Liu's color-segmentation equation: with this set of XYZ, we can calculate xₗ, yₗ required by Dₗxₗyₗ profile connection color space as below:

$${x}_{l} = {x}_{o} = \frac{X}{X + Y + Z} \qquad {y}_{l} = {y}_{o} = \frac{Y}{X + Y + Z}$$

(b) Segment XYZ using Liu's color-segmentation equation: calculate gray value p by solving Liu's color-segmentation equation;

(c) Plug p into luminance formula of Liu's color-segmentation equation (gray scale format), then calculate gray scale's luminance value in color XₗYₗZₗ:

Yₗ=Yᵥ=Y_{w}(1−p)+pYₛₖ

(d) Convert gray scale's luminance value Yₗ into gray density value Dₗ: Dₗ=Dₒ=lg(Y_{wo}/Yₒ)

After above 4 steps, any color XYZ in XYZ color space or scanned color XYZ has been converted into Dₒxₒyₒ of profile connection color space.

(2) A method to create Dₗxₗyₗ profile connection color space for scanner in RGB color space

Step 1. Create Liu's color-segmentation equation for scanner:

(a) Format of Liu's color-segmentation equation for scanner In RGB color space. 3 sub-types are as follows,

$$\{ \begin{matrix}R = [ \begin{matrix}( 1 - {c}^{′} ) ( 1 - {m}^{′} ) {R}_{w} + c ( 1 - {m}^{′} ) {R}_{c} + \\ ( 1 - {c}^{′} ) {m}^{′} {R}_{m} + {c}^{′} {m}^{′} {R}_{b}\end{matrix} ] \cdot ( 1 - p ) + p \cdot {R}_{sk} \\ G = [ \begin{matrix}( 1 - {c}^{′} ) ( 1 - {m}^{′} ) {G}_{w} + c ( 1 - {m}^{′} ) {G}_{c} + \\ ( 1 - {c}^{′} ) {m}^{′} {G}_{m} + {c}^{′} {m}^{′} {G}_{b}\end{matrix} ] \cdot ( 1 - p ) + p \cdot {G}_{sk} \\ B = [ \begin{matrix}( 1 - {c}^{′} ) ( 1 - {m}^{′} ) {B}_{w} + c ( 1 - {m}^{′} ) {B}_{c} + \\ ( 1 - {c}^{′} ) {m }^{′} {B}_{m} + {c}^{′} {m}^{′} {B}_{b}\end{matrix} ] \cdot ( 1 - p ) + p \cdot {B}_{sk}\end{matrix} \\ \{ \begin{matrix}R = [ \begin{matrix}( 1 - {c}^{′} ) ( 1 - {y}^{′} ) {R}_{w} + c ( 1 - {y}^{′} ) {R}_{c} + \\ ( 1 - {c}^{′} ) {y}^{′} {R}_{y} + {c}^{′} {y}^{′} {R}_{g}\end{matrix} ] \cdot ( 1 - p ) + p \cdot {R}_{sk} \\ G = [ \begin{matrix}( 1 - {c}^{′} ) ( 1 - {y}^{′} ) {G}_{w} + c ( 1 - {y}^{′} ) {G}_{c} + \\ ( 1 - {c}^{′} ) {y}^{′} {G}_{y} + {c}^{′} {y}^{′} {G}_{g}\end{matrix} ] \cdot ( 1 - p ) + p \cdot {G}_{sk} \\ Z = [ \begin{matrix}( 1 - {c}^{′} ) ( 1 - {y}^{′} ) {B}_{w} + c ( 1 - {y}^{′} ) {B}_{c} + \\ ( 1 - {c}^{′} ) {y }^{′} {B}_{y} + {c}^{′} {y}^{′} {B}_{g}\end{matrix} ] \cdot ( 1 - p ) + p \cdot {B}_{sk}\end{matrix} \\ \{ \begin{matrix}R = [ \begin{matrix}( 1 - {m}^{′} ) ( 1 - {y}^{′} ) {R}_{w} + m ( 1 - {y}^{′} ) {R}_{m} + \\ ( 1 - {m}^{′} ) {y}^{′} {R}_{y} + {m}^{′} {y}^{′} {R}_{r}\end{matrix} ] \cdot ( 1 - p ) + p \cdot {R}_{sk} \\ G = [ \begin{matrix}( 1 - {m}^{′} ) ( 1 - {y}^{′} ) {G}_{w} + m ( 1 - {y}^{′} ) {G}_{m} + \\ ( 1 - {m}^{′} ) {y}^{′} {G}_{y} + {m}^{′} {y}^{′} {G}_{r}\end{matrix} ] \cdot ( 1 - p ) + p \cdot {G}_{sk} \\ B = [ \begin{matrix}( 1 - {m}^{′} ) ( 1 - {y}^{′} ) {B}_{w} + m ( 1 - {y}^{′} ) {B}_{m} + \\ ( 1 - {m}^{′} ) {y }^{′} {B}_{y} + {m}^{′} {y}^{′} {B}_{r}\end{matrix} ] \cdot ( 1 - p ) + p \cdot {B}_{sk}\end{matrix}$$

In above equation, let values in square bracket on right side of equation equals to solid white color's tristimulus value measured on scanner color target, i.e. R_{w}, G_{w}, B_{w}, then Liu's color-segmentation equation turns into gray scale format of Liu's color-segmentation equation as follows:

Rᵥ=R_{w}·(1−p)+p·Rₛₖ

Gᵥ=G_{w}·(1−p)+p·Gₛₖ

Vᵥ=B_{w}·(1−p)+p·Bₛₖ

If we plug [pᵢ] into left side of each Liu's color-segmentation equation (gray scale format), then the generated tristimulus array [Rᵥᵢ, Gᵥᵢ, Bᵥᵢ] is equivalent to pure gray scale's tristimulus value [Rₒᵢ, Gₒᵢ, Bₒᵢ];

Step 2, Calculate gray density value for gray component Rᵥ, Gᵥ, Bᵥ:
(a) Segment RGB using Liu's color-segmentation equation, i.e. calculate gray value p by solving Liu's color-segmentation equation;
(b) Plug value p into luminance calculation expression in Liu's color-segmentation equation (gray scale format) to calculate gray scale's luminance value of RᵥGᵥBᵥ:

Gₗ=Gᵥ=G_{w}(1−p)+pGₛₖ
(c) Convert gray scale's luminance value Gₗ into gray density value D_{rgb} as:

D_{rgb}=Dₗ=lg(G_{wo}/Gᵥ)

Benefit of Dₗxₗyₗ profile connection color space:

(1) The conversion from XYZ to Dₗxₗyₗ is accurate and won't incur error for following mapping transformation;

(2) Dₗxₗyₗ profile connection color space is created using Liu's color-segmentation equation as a tool; in essence, the process is separate a color XYZ into luminance signal Dₗ and chromaticity signal xₗyₗ. As to television and satellite communication, with the help of parameter p in Liu's color-segmentation equation, color image signal can be transmitted with constant luminance and chromaticity, lossless high compression to conserve bandwidth at the same time;

(3) In color management system, Dₗxₗyₗ profile connection space is a universal path to achieve universal color mapping.

9. A method to rapidly calculate reference primary value c′m′y′ in RGB space and Liu's 3-primary color clamping equation

Objective: existing method to convert scanned RGB data to CIEXYZ is creating conversion polynomial with regression analysis. It incurs obvious conversion error. Furthermore, regression analysis is mathematics approximation method and has nothing to do with gamut mapping which falls in field of visual psychology, so it does not accord with gamut mapping rules. Based on colorimetry concept, this invention converts RGB into reference primary value c′m′y′ in RGB space, then converts reference primary c′m′y′ to scan primary value cmy in XYZ color space; finally plug cmy into scanning color prediction equation to convert value RGB from scanner to value CIEXYZ accurately. In above steps, the method to convert RGB to twin primary value c′m′y′ is based on Liu's 3-primary color clamping equation.

Format of Liu's 3-primary clamping equation:

Liu's 3-primary clamping equation inherits type property from Liu's color-segmentation equation, and has 3 sub-types: CMK, CYK, MYK. The decision to choose the correct equation type to convert color RGB is made based on the minimum value of RGB. The 3 sub-types of Liu's 3-primary clamping equation are listed as below:

$$\{ \begin{matrix}λ R = \begin{matrix}( 1 - {y}_{dd}^{′} ) ( 1 - {m}^{′} ) ( 1 - {c}^{′} ) {R}_{w} + ( 1 - {y}_{dd}^{′} ) ( 1 - {m}^{′} ) {c}^{′} {R}_{c} + ( 1 - {y}_{dd}^{′} ) {m}_{x}^{′} ( 1 - {c}^{′} ) {R}_{m} + {y}_{dd}^{′} ( 1 - {m}^{′} ) ( 1 - {c}^{′} ) {R}_{y} + \\ {y}_{dd}^{′} {m}^{′} ( 1 - {c}^{′} ) {R}_{r} + {y}_{dd}^{′} ( 1 - {m}^{′} ) {c}^{′} {R}_{g} + ( 1 - {y}_{dd}^{′} ) {m}^{′} {c}^{′} {R}_{b} + {y}_{dd}^{′} {m}^{′} {c}^{′} {R}_{s}\end{matrix} \\ λ G = ( 1 - {y}_{dd}^{′} ) ( 1 - {m}^{′} ) ( 1 - {c}^{′} ) {G}_{w} + ( 1 - {y}_{dd}^{′} ) ( 1 - {m}^{′} ) {c}^{′} {G}_{c} + ( 1 - {y}_{dd}^{′} ) {m}^{′} ( 1 - {c}^{′} ) {G}_{m} + … + {y}_{dd}^{′} {m}^{′} {c}^{′} {G}_{s} \\ λ B = ( 1 - {y}_{dd}^{′} ) ( 1 - {m}^{′} ) ( 1 - {c}^{′} ) {B}_{w} + ( 1 - {y}_{dd}^{′} ) ( 1 - {m}^{′} ) {c}^{′} {B}_{c} + ( 1 - {y}_{dd}^{′} ) {m}^{′} ( 1 - {c}^{′} ) {B}_{m} + … + {y}_{dd}^{′} {m}^{′} {c}^{′} {B}_{s}\end{matrix} \\ \{ \begin{matrix}λ R = ( 1 - {y}^{′} ) ( 1 - {m}_{dd}^{′} ) ( 1 - {c}^{′} ) {R}_{w} + ( 1 - {y}^{′} ) ( 1 - {m}_{dd}^{′} ) {c}^{′} {R}_{c} + ( 1 - {y}^{′} ) {m}_{dd}^{′} ( 1 - {c}^{′} ) {R}_{m} + … + {y}^{′} {m}_{dd}^{′} {c}^{′} {R}_{s} \\ λ G = ( 1 - {y}^{′} ) ( 1 - {m}_{dd}^{′} ) ( 1 - {c}^{′} ) {G}_{w} + ( 1 - {y}^{′} ) ( 1 - {m}_{dd}^{′} ) {c}^{′} {G}_{c} + ( 1 - {y}^{′} ) {m}_{dd}^{′} ( 1 - {c}^{′} ) {G}_{m} + … + {y}^{′} {m}_{dd}^{′} {c}^{′} {G}_{s} \\ λ B = ( 1 - {y}^{′} ) ( 1 - {m}_{dd}^{′} ) ( 1 - {c}^{′} ) {B}_{w} + ( 1 - {y}^{′} ) ( 1 - {m}_{dd}^{′} ) {c}^{′} {B}_{c} + ( 1 - {y}^{′} ) {m}_{dd}^{′} ( 1 - {c}^{′} ) {B}_{m} + … + {y}^{′} {m}_{dd}^{′} {c}^{′} {B}_{s}\end{matrix} \\ \{ \begin{matrix}λ R = ( 1 - {y}^{′} ) ( 1 - {m}^{′} ) ( 1 - {c}_{dd}^{′} ) {R}_{w} + ( 1 - {y}^{′} ) ( 1 - {m}^{′} ) {c}_{dd}^{′} {R}_{c} + ( 1 - {y}^{′} ) {m}_{x}^{′} ( 1 - {c}_{dd}^{′} ) {R}_{m} + … + {y}^{′} {m}^{′} {c}_{dd}^{′} {R}_{s} \\ λ G = ( 1 - {y}^{′} ) ( 1 - {m}^{′} ) ( 1 - {c}_{dd}^{′} ) {G}_{w} + ( 1 - {y}^{′} ) ( 1 - {m}^{′} ) {c}_{dd}^{′} {G}_{c} + ( 1 - {y}^{′} ) {m}^{′} ( 1 - {c}_{dd}^{′} ) {G}_{m} + … + {y}^{′} {m}^{′} {c}_{dd}^{′} {G}_{s} \\ λ B = ( 1 - {y}^{′} ) ( 1 - {m}^{′} ) ( 1 - {c}_{dd}^{′} ) {B}_{w} + ( 1 - {y}^{′} ) ( 1 - {m}^{′} ) {c}_{dd}^{′} {B}_{c} + ( 1 - {y}^{′} ) {m}^{′} ( 1 - {c}_{dd}^{′} ) {B}_{m} + … + {y}^{′} {m}^{′} {c}_{dd}^{′} {B}_{s}\end{matrix}$$

In above, λ is Liu's color appearance keeping parameter, c_{dd}′, m_{dd}′, y_{dd}′ are gray core parameters from scanner gray balance power function expression. If type CMK of Liu's 3-primary color clamping equation is chosen to perform conversion for color RGB, only gray core value y_{dd} needs to be calculated, then dynamically plug y_{dd} into Liu's 3-primary color clamping equation to get a quadratic equation with only 3 unknown values λ, c′, m′, and can be solved quickly with analytical algorithm. An equally important thing is: with joint effect of Liu's color appearance keeping parameter λ and gray core y_{dd}, type CMK of Liu's 3-primary color clamping equation grant primary value c′, m′, y′=y_{dd} with characteristic of reference primary value. If type CYK or MYK of Liu's 3-primary color clamping equation is chosen, then repeat the same procedure as above except substitute gray core y_{dd}′ with m_{dd} or c_{dd}.

10. A method to convert scanned color from RGB color space to CIEXYZ color space:

Objective: scanner captures RGB data reflected by color target image via CCD sensor, we can assume scanner's CCD sensor has lineal response to amount of censored light; while XYZ value generated by scanned color target is non-lineal. The following method explains how to perform RGB-CIEXYZ color space conversion for scanned RGB data in accordance with colorimetry theory.

Procedure:

(1) Observe the RGB tristimulus value obtained by scanner and choose the segmentation equation based on the minimum value in R, G, B. The selection criteria are: if R is minimum value, choose GBK segmentation equation; if G is minimum value, choose RBK segmentation equation; if B is minimum value, choose RGK segmentation equation;

(2) Plug tristimulus value RGB captured by scanner in left side of color-segmentation equation (type GBK) to solve black value p;

(3) Plug black value p into gray scale format of Liu's color-segmentation equation to get gray luminance Gₗ: Gₗ=G_{w}(1−p)+p Gₛₖ

(4) Convert Gₗ into density value D_{rgb}: D_{rgb}=lg(G_{wo}/Gₗ); in which G_{wo} is luminance value measured on white area of scanned color target;

(5) Plug D_{rgb} into scanner's gray balance power function to get gray core value c_{dd}′;

(6) Plug gray core value c_{dd}′ into Liu's color-segmentation equation (type GBK) to get component primary value c′, m′, y′ of color RGB;

(7) Plug primary value c′, m′, y′ into scanner's conversion formula c′m′y′-cmy to calculate reference primary value c, m, y;

(8) Plug reference primary value c, m, y into scanner color-matching equation to get target value XYZ.

11. A method to create Dₗxₗyₗ profile connection color space for digital camera or digital television camera

Objective: digital camera, scanner or other image input device can be seen as composed of CCD sensor device's RGB-CIEXYZ coordinates conversion module and color target's nonlinear reflection process module. This concept helps to solve the problem accurately, easily and meet the mapping requirement.

Procedure: although digital camera and digital television camera use different CCD device, Dₗxₗyₗ profile connection color space can be created using same format of Liu's color-segmentation equation; the steps are as follows:

(1) After thoroughly considering general demands of current multimedia devices, a set of generally recognized chromaticity coordinates for color-matching three primary colors RGB is created, let chromaticity coordinates of white dot equal to that of reference white D65. Below is the matrix equation and luminance equation to perform the coordinate conversion from RGB to XYZ. The conversion result is accurate because this method is the geometric linear conversion of the same color in different color gauging system.

$$[ \begin{matrix}X \\ Y \\ Z\end{matrix} ] = [ \begin{matrix}{a}_{11} & {a}_{a 12} & {a}_{13} \\ {a}_{21} & {a}_{a 22} & {a}_{23} \\ {a}_{31} & {a}_{a 32} & {a}_{33}\end{matrix} ] [ \begin{matrix}R \\ G \\ B\end{matrix} ]$$

$$Y = {a}_{21} R + {a}_{21} G + {a}_{21} B$$

Plug a random RGB value captured by CCD image sensor component into the above RGB-XYZ matrix equation to perform the RGB-XYZ color space coordinate data conversion.

(2) Below is function on creating gray scale format of Liu's segmentation equation for

X_{greyi}=Xₛₖ·(1−Y)+Y·X_{sw}

standard monitor: Y_{greyi}=Yₛₖ·(1−Y)+Y·Y_{sw}

Z_{greyi}=Zₛₖ·(1−Y)+Y·Z_{sw}

In which, X_{gray}Y_{gray}Z_{gray} is tristimulus of pure gray of standard monitor,
X_{w}Y_{w}Z_{w} is tristimulus of white point of standard monitor,
XₖYₖZₖ is tristimulus of black point of standard monitor;

(3) Convert gray scale luminance value Y_{gray} into gray density Dₗ as Dₗ=Dₙ=lg(Y_{w}/Y_{gray})

(4) Calculate chromaticity coordinates of color XYZ based on XYZ on left side of RGB-XYZ matrix equation: with XYZ values, xₗ, yₗ in Dₗxₗyₗ profile connection color space can be calculated as follows:

xₗ=xₙ=X/(X+Y+Z), yₗ=yₙ=Y/(X+Y+Z)

After the above 4 steps, scan color XYZ is converted into profile connection space value DₙXₙYₙ.

12. A method to map parameter Dₗ of profile connection space to gray tone parameter of target device gamut

Objective: create a universal method to seamlessly link parameter Dₗ of profile connection space with gray tone density of target color gamut;

Procedure: following above steps, we have got gray tone density arrays [Dₙᵢ], [Dₒᵢ], [Dₚᵢ], [D_{qwi}], [D_{qki}] in device gamut (the device can be digital camera, digital video camera, scanner, monitor, printer or press). Based on mapping relationships between these arrays, we can get density mapping function with input device's gray tone density array as independent variable, output device's gray tone density array as dependent variable. Density mapping functions are as follows:

(1) Map digital camera's gray tone density array [Dₙᵢ] to gamut of normally-white-monitor (computer monitor): do power function fitting with camera's gray tone density array [Dₙᵢ] as independent variable and normally-white-monitor's gray tone density array [D_{qwi}] as dependent variable to get gray density mapping function between digital camera and computer monitor:

D_{qw}=Dₙ^{γ}^{_{qw}}

(2) Map television camera's gray tone density array [Dₙᵢ] to gamut of normally-black-monitor (television monitor): perform power function fitting with television camera's gray tone density array [Dₙᵢ] as independent variable and normally-black-monitor's gray tone density array [D_{qki}] as dependent variable to get gray tone density mapping function between television camera and television monitor: D_{qk}=Dₙ^{γ}^{_{qk}}

(3) Map scanner's gray tone density array [Dₒᵢ] to gamut of printer or press: perform power function fitting with scanner's gray tone density array [Dₒᵢ] as independent variable and printing device's gray tone density array [Dₚᵢ] as dependent variable to get gray density mapping function between scanner and printer (or press): Dₚ=Dₒ^{γ}^{ₚₒ}

(4) Map printer or press's gray tone density array [Dₚᵢ] to gamut of display device: perform power function fitting with printer or press's gray tone density array [Dₚᵢ] as independent variable and normally-white-monitor's gray tone density array [D_{qwi}] as dependent variable to get gray density mapping function between printer (or press) and monitor: D_{qw}=Dₚ^{γ}^{_{qwp}}

13. A method to map color from source device to gamut of target device

Objective: Create a method to transform Dₗxₗyₗ in profile connection space to target gamut without data loss.

(1) A method to map color obtained by scanner to gamut of printer device

Method: gamut mapping between scanner and printer device is performed by transferring Dₒ, xₒ, yₒ of profile connection space to gamut of printer device with the help of Liu's scanner-printer gamut mapping equation.

Procedure:

Step 1, Based on scanned RGB, choose proper sub-type of Liu's scanner-printer mapping equation: Liu's scanner-printer mapping equation has 3 sub-types: CM K, CYK and MYK. There is one-to-one relationship between them and sub-types of Liu's color-segmentation equation; following are the equation of 3 sub-types:

$$\{ \begin{matrix}( {x}_{o} / {y}_{o} ) {Y}_{p} = \begin{matrix}( 1 - {c}_{dd} ) ( 1 - m ) ( 1 - y ) ( 1 - {k}_{dd} ) {X}_{w} + {c}_{dd} ( 1 - m ) ( 1 - y ) ( 1 - {k}_{dd} ) {X}_{c} + ( 1 - {c}_{dd} ) m ( 1 - y ) ( 1 - {k}_{dd} ) {X}_{m} + \\ ( 1 - {c}_{dd} ) ( 1 - m ) y ( 1 - {k}_{dd} ) {X}_{y} + ( 1 - {c}_{dd} ) my ( 1 - {k}_{dd} ) {X}_{r} + {c}_{dd} ( 1 - m ) y ( 1 - {k}_{dd} ) {X}_{g} + {c}_{dd} m ( 1 - y ) ( 1 - {k}_{dd} ) {X}_{b} + \\ {c}_{dd} my ( 1 - {k}_{dd} ) {X}_{s} + ( 1 - {c}_{dd} ) ( 1 - m ) ( 1 - y ) {k}_{dd} {X}_{k} + {c}_{dd} ( 1 - m ) ( 1 - y ) {k}_{dd} {X}_{ck} + ( 1 - {c}_{dd} ) m ( 1 - y ) {k}_{dd} {X}_{mk} + \\ ( 1 - {c}_{dd} ) ( 1 - m ) y {k}_{dd} {X}_{yk} + ( 1 - {c}_{dd} ) m y {k}_{dd} {X}_{tk} + {c}_{dd} ( 1 - m ) y {k}_{dd} {X}_{gk} + {c}_{dd} m ( 1 - y ) {k}_{dd} {X}_{bk} + {c}_{dd} m y {k}_{dd} {X}_{sk}\end{matrix} \\ {Y}_{p} = ( 1 - {c}_{dd} ) ( 1 - m ) ( 1 - y ) ( 1 - {k}_{dd} ) {Y}_{w} + {c}_{dd} ( 1 - m ) ( 1 - y ) ( 1 - {k}_{dd} ) {Y}_{c} + ( 1 - {c}_{dd} ) m ( 1 - y ) ( 1 - {k}_{dd} ) {Y}_{m} + … + {c}_{dd} m y {k}_{dd} {Y}_{ck} \\ [ ( 1 - {x}_{o} - {y}_{o} ) / {y}_{o} ] {Y}_{p} = ( 1 - {c}_{dd} ) ( 1 - m ) ( 1 - y ) ( 1 - {k}_{dd} ) {Z}_{w} - {c}_{dd} ( 1 - m ) ( 1 - y ) ( 1 - {k}_{dd} ) {Z}_{c} + … + {c}_{dd} m y {k}_{dd} {Z}_{sk}\end{matrix} \\ \{ \begin{matrix}( {x}_{o} / {y}_{o} ) {Y}_{p} = ( 1 - c ) ( 1 - {m}_{dd} ) ( 1 - y ) ( 1 - {k}_{dd} ) {X}_{w} + c ( 1 - {m}_{dd} ) ( 1 - y ) ( 1 - {k}_{dd} ) {X}_{c} + … + c {m}_{dd} y {k}_{dd} {X}_{sk} \\ {Y}_{p} = ( 1 - c ) ( 1 - {m}_{dd} ) ( 1 - y ) ( 1 - {k}_{dd} ) {Y}_{w} + c ( 1 - {m}_{dd} ) ( 1 - y ) ( 1 - {k}_{dd} ) {Y}_{c} + ( 1 - c ) {m}_{dd} ( 1 - y ) ( 1 - {k}_{dd} ) {Y}_{m} + … + c {m}_{dd} y {k}_{dd} {Y}_{sk} \\ [ ( 1 - {x}_{o} - {y}_{o} ) / {y}_{o} ] {Y}_{p} = ( 1 - c ) ( 1 - {m}_{dd} ) ( 1 - y ) ( 1 - {k}_{dd} ) {Z}_{w} + c ( 1 - {m}_{dd} ) ( 1 - y ) ( 1 - {k}_{dd} ) {Z}_{c} + … + c {m}_{dd} y {k}_{dd} {Z}_{sk}\end{matrix} \\ \{ \begin{matrix}( {x}_{o} / {y}_{o} ) {Y}_{p} = ( 1 - c ) ( 1 - m ) ( 1 - {y}_{dd} ) ( 1 - {k}_{dd} ) {X}_{w} + c ( 1 - m ) ( 1 - {y}_{dd} ) ( 1 - {k}_{dd} ) {X}_{c} + … + c m {y}_{dd} {k}_{dd} {X}_{sk} \\ {Y}_{p} = ( 1 - c ) ( 1 - m ) ( 1 - {y}_{dd} ) ( 1 - {k}_{dd} ) {Y}_{w} + c ( 1 - m ) ( 1 - {y}_{dd} ) ( 1 - {k}_{dd} ) {Y}_{c} + ( 1 - c ) m ( 1 - {y}_{dd} ) ( 1 - {k}_{dd} ) {Y}_{m} + … + c m {y}_{dd} {k}_{dd} {Y}_{sk} \\ [ ( 1 - {x}_{o} - {y}_{o} ) / {y}_{o} ] {Y}_{p} = ( 1 - c ) ( 1 - m ) ( 1 - {y}_{dd} ) ( 1 - {k}_{dd} ) {Z}_{w} + c ( 1 - m ) ( 1 - {y}_{dd} ) ( 1 - {k}_{dd} ) {Z}_{c} + … + c m {y}_{dd} {k}_{dd} {Z}_{sk}\end{matrix}$$

For the sake of simplicity, we only take MYK equation as an example. Plug scanner's chromaticity coordinates xₒ and yₒ from Dₗxₗyₗ profile connection space to left of the equation, parameter Yₚ is an unknown luminance parameter. Yₚ has the clamping luminance characteristic and is called Liu's clamping luminance The left side of the equation shows scanned output color Dₒxₒyₒ is going to be printed as a new color after processed by scan-print mapping equation. Let's say Xₚ, Yₚ, Zₚ is the new color; XₚYₚZₚ actually is the value from left side of the equation. CMYK is the driving value for displaying color Xₚ, Yₚ, Zₚ.

Xₚ=(xₒ/yₒ)Yₚ, Yₚ=Yₚ, Zₚ=[(1−xₒ−yₒ)/yₒ]Yₚ

Step 2, Map scanner color space's gray tone density Dₒ to gray tone density Dₚ of printer device's gamut:

a, let Dₚ=Dₒ^{γ}^{ₚₒ}

b, Calculate Gamma correction density: let Dₚ′=Dₚ^{1/γ}^{ₚ}^{²}=(Dₒ^{γ}^{ₚₒ})^{1/γ}^{ₚ}^{²}=Dₒ^{γ}^{ₚₒ}^{/γ}^{ₚ}^{²}

c, Substitute Dₚ in printer's gray balance polynomial with Gamma correction density Dₚ′ to get Liu's 4-primary color printing anti-Gamma gray balance polynomial, with which we can calculate Gamma corrected gray balance component value cₚ, mₚ, yₚ and gray substitute parameter kₚ; cₚ, mₚ, yₚ, kₚ can be used as gray cores;

cₚ=c_{dd}=a₀+a₁Dₚ′+a₂Dₚ′²+a₃Dₚ′³+ . . . , mₚ=m_{dd}=b₀+b₁Dₚ′+b₂Dₚ′²+b₃Dₚ′³+ . . .

yₚ=y_{dd}=c₀+c₁Dₚ′+c₂Dₚ′²+c₃Dₚ′³+ . . . , kₚ=k_{dd}=d₀+d₁Dₚ′+d₂Dₚ′²+d₃Dₚ′³+ . . .

If CMK or CYK type equation is chosen, k_{dd}, m_{dd} or k_{dd}, y_{dd} need to be calculated instead of k_{dd}, c_{dd};

d, based on chosen sub-type of Liu's scanner printer mapping equation, plug k_{dd}, c_{dd} (or k_{dd}, m_{dd}, or k_{dd}, y_{dd}) into right side of chosen sub-type of 4-primary color mapping equation;

As shown above, the two new symbols c_{dd}, k_{dd} on the right side of the equation are not variables. They are values provided by cmyk gray balance polynomial. For type MYK equation, c_{dd}=c, which comes from printer gray balance equation. The independent variable in gray balance polynomial turns into Dₚ. The gray color parameter Dₒ from Dₒxₒyₒ profile connection space is related to Liu's scanner printer equation mapping equation via Dₚ and c_{dd}. k_{dd} is gray component substitute value of the color to be transformed. The variable of the equation is m, y and Yₚ, which helps to produce the color XₚYₚZₚ on the left of the equation. Similar to Liu's primary clamping equation, variable Yₚ also acts as color appearance keeping coefficient. It ensures the new color XₚYₚZₚ and color XYZ from scanner output has the same color appearance with consistent visual effect. The three primary value c=c_{dd}, m, y and c_{dd} calculated using type MYK of Liu's scanner-printer mapping equation are Gamma corrected reference primary value.

Step 3, Calculate driving value CMYK which makes up color Xₚ, Yₚ, Zₚ based on 3 primary value c=c_{dd}, m, y derived from Liu's scanner-printer mapping equation. In the equation, reference primary cmyk is the function of driving input value d_{c} dₘ d_{y} dₖ. Printer reference primary cmyk can be converted into driving input value CMYK as follows:

C=d_{cp}=Dₚ^{1/γ}^{ₚ}=(cₚ^{1/γ}^{_{cd}})^{1/γ}^{ₚ}=c^{1/(γ}^{_{cd}}^{γ}^{ₚ₎}, M=dₘₚ=Dₚ^{1/γ}^{ₚ}=(mₚ^{1/γ}^{_{md}})^{1/γ}^{ₚ}=m^{1/(γ}^{_{md}}^{γ}^{ₚ₎}

Y=d_{yp}=Dₚ^{1/γ}^{ₚ}=(yₚ^{1/γ}^{_{yd}})^{1/γ}^{ₚ}=y^{1/(γ}^{_{yd}}^{γ}^{ₚ₎}, K=dₖₚ=Dₚ^{1/γ}^{ₚ}=(kₚ^{1/γ}^{_{kd}})^{1/γ}^{ₚ}=kₚ^{1/(γ}^{_{kd}}^{γ}^{ₚ₎}

(2) A method to map color XYZ captured by digital camera to color gamut of normally-white-monitor

Method: gamut mapping between digital camera and display device is performed by transferring profile connection space parameter Dₙ, xₙ, yₙ to display device with the help of digital camera-monitor mapping equation.

Procedure:

Step 1, map digital camera color space's gray tone density Dₙ to gray tone density D_{q} of display device gamut:

a, Let D_{qw}=Dₙ^{γ}^{_{qnw}} b, Calculate Gamma correction density D_{qw}′=D_{qw}^{1/γ}^{_{qw}}^{²}

c, Plug Gamma correction density D_{qw}′ into normally-white-monitor's gray balance component primary power function to calculate gray balance component primary value (used as gray core) and gray substitute parameter kₚ:

r_{dd}=(D_{qw}′)^{γ}^{_{rd}}=(D_{qw}^{1/γ}^{_{qw}}^{²})^{γ}^{_{rd}}=D_{qw}^{γ}^{_{rd}}^{/γ}^{_{qw}}^{²}, g_{dd}=(D_{qw}′)^{γ}^{_{gd}}=D_{qw}^{γ}^{_{gd}}^{/γ}^{_{qw}}^{²}, b_{dd}=(D_{qw}′)^{γ}^{_{bd}}=D_{qw}^{γ}^{_{bd}}^{/γ}^{_{qw}}^{²}

Step 2, map chromaticity coordinates xₙ and yₙ of input device profile connection space to normally-white-monitor, then finish mapping using Liu's digital camera-monitor mapping equation:

Liu's digital camera-monitor mapping equation has 3 sub-types: r_{dd}gb, rg_{dd}b, rgb_{dd}. There is one-to-one relationship between them and sub-types of Liu's color-segmentation equation; following are the 3 sub-types:

$$\{ \begin{matrix}( {x}_{n} / {y}_{n} ) {Y}_{qw} = \begin{matrix}( 1 - {r}_{dd} ) ( 1 - g ) ( 1 - b ) {X}_{w} + ( 1 - {r}_{dd} ) {g}_{d} ( 1 - b ) {X}_{m} + ( 1 - {r}_{dd} ) ( 1 - g ) b {X}_{y} + \\ ( 1 - {r}_{dd} ) g b {X}_{r} + {r}_{dd} ( 1 - g ) ( 1 - b ) {X}_{c} + {r}_{dd} ( 1 - g ) b {X}_{g} + {r}_{dd} g ( 1 - b ) {X}_{b} + {r}_{dd} g b {X}_{sk}\end{matrix} \\ {Y}_{qw} = ( 1 - {r}_{dd} ) ( 1 - g ) ( 1 - b ) {Y}_{w} + ( 1 - {r}_{dd} ) g ( 1 - b ) {Y}_{m} + ( 1 - {r}_{dd} ) ( 1 - g ) b {Y}_{y} + … + {r}_{dd} g b {Y}_{sk} \\ [ ( 1 - {x}_{n} - {y}_{n} ) / {y}_{n} ] {Y}_{qw} = ( 1 - {r}_{dd} ) ( 1 - g ) ( 1 - b ) {Z}_{w} + ( 1 - {r}_{dd} ) g ( 1 - b ) {Z}_{m} + ( 1 - {r}_{dd} ) ( 1 - g ) b {Z}_{y} + … + {r}_{dd} g b {Z}_{sk}\end{matrix} \\ \{ \begin{matrix}( {x}_{n} / {y}_{n} ) {Y}_{qw} = \begin{matrix}( 1 - r ) ( 1 - {g}_{dd} ) ( 1 - b ) {X}_{w} + ( 1 - r ) {g}_{dd} ( 1 - b ) {X}_{m} + ( 1 - r ) ( 1 - {g}_{dd} ) b {X}_{y} + \\ ( 1 - r ) {g}_{dd} b {X}_{r} + r ( 1 - {g}_{dd} ) ( 1 - b ) {X}_{c} + r ( 1 - {g}_{dd} ) b {X}_{g} + {r}_{d} g ( 1 - b ) {X}_{b} + r {g}_{dd} b {X}_{sk}\end{matrix} \\ {Y}_{qw} = ( 1 - r ) ( 1 - {g}_{dd} ) ( 1 - b ) {Y}_{w} + ( 1 - r ) {g}_{dd} ( 1 - b ) {Y}_{m} + ( 1 - r ) ( 1 - {g}_{dd} ) b {Y}_{y} + … + r {g}_{dd} b {Y}_{sk} \\ [ ( 1 - {x}_{n} - {y}_{n} ) / {y}_{n} ] {Y}_{qw} = ( 1 - r ) ( 1 - {g}_{dd} ) ( 1 - b ) {Z}_{w} + ( 1 - r ) {g}_{dd} ( 1 - b ) {Z}_{m} + ( 1 - r ) ( 1 - {g}_{dd} ) b {Z}_{y} + … + r {g}_{dd} b {Z}_{sk}\end{matrix} \\ \{ \begin{matrix}( {x}_{n} / {y}_{n} ) {Y}_{qw} = \begin{matrix}( 1 - r ) ( 1 - g ) ( 1 - {b}_{dd} ) {X}_{w} + ( 1 - r ) g ( 1 - {b}_{dd} ) {X}_{m} + ( 1 - r ) ( 1 - g ) {b}_{dd} {X}_{y} + \\ ( 1 - r ) g {b}_{dd} {X}_{r} + r ( 1 - g ) ( 1 - {b}_{dd} ) {X}_{c} + r ( 1 - g ) {b}_{dd} {X}_{g} + r g ( 1 - {b}_{dd} ) {X}_{b} + r g {b}_{dd} {X}_{sk}\end{matrix} \\ {Y}_{qw} = ( 1 - r ) ( 1 - g ) ( 1 - {b}_{dd} ) {Y}_{w} + ( 1 - r ) g ( 1 - {b}_{dd} ) {Y}_{m} + ( 1 - r ) ( 1 - g ) {b}_{dd} {Y}_{y} + … + r g {b}_{dd} {Y}_{sk} \\ [ ( 1 - {x}_{n} - {y}_{n} ) / {y}_{n} ] {Y}_{qw} = ( 1 - r ) ( 1 - g ) ( 1 - {b}_{dd} ) {Z}_{w} + ( 1 - r ) g ( 1 - {b}_{dd} ) {Z}_{m} + ( 1 - r ) ( 1 - g ) {b}_{dd} {Z}_{y} + … + r g {b}_{dd} {Z}_{sk}\end{matrix}$$

Choose a sub-type from r_{dd}gb, rg_{dd}b, rgb_{d}, plug r_{dd}, g_{dd}, b_{dd} (calculated in step 1) into right side of equation; plug xₙyₙ and Liu's clamping luminance Y_{qw} into left side of equation to solve Gamma corrected and gamut mapped reference primary value r,g,b and luminance value Y_{qw}.

In above, driving input value dᵣd_{g}d_{b} is also function of reference primary value rgb. Hence we get solution to convert normally-white-monitor reference primary value rgb to driving input value RGB:

R=d_{qw}=D_{qw}^{1/γ}^{_{qw}}=(r_{qw}^{1/γ}^{_{rdw}})^{1/γ}^{_{qw}}=r^{1/(γ}^{_{rd}}^{γ}^{_{qw)}}G=d_{qw}=D_{qw}^{1/γ}^{_{qw}}=(g_{qw}^{1/γ}^{_{gdw}})^{1/γ}^{_{qw}}=g^{1/(γ}^{_{gd}}^{γ}^{_{qw)}}B=d_{qw}=D_{qw}^{1/γ}^{_{qw}}=(b_{qw}^{1/γ}^{_{bdw}})^{1/γ}^{_{qw}}=b^{1/(γ}^{_{bd}}^{γ}^{_{qw)}}

The 3 primary values calculated respectively using 3 different types of Liu's comprehensive mapping equation are all Gamma corrected primary value.

Let X_{qw}=(xₙ/yₙ)Yₜ, Y_{qw}=Yₜ, Z_{qw}=[(1−xₙ−yₙ)/yₙ]Yₜ, the final display color is X_{qw}, Y_{qw}, Z_{qw} and RGB is driving value used to display color X_{qw}, Y_{qw}, Z_{qw}.

(3) A method to map color XYZ captured by television video camera to gamut of normally-black television monitor

Method: gamut mapping between television video camera and television display device is performed by transferring profile connection space parameter Dₙ, xₙ, yₙ to display device with the help of television video camera-television monitor mapping equation.

Procedure:

Step 1, Map gray tone density Dₙ of television video camera color space to gray tone density D_{qk} of display device gamut.

a, Let D_{qk}=Dₙ^{γ}^{_{qnk}} b, Calculate Gamma correction density: let D_{qk}′=D_{qk}^{1/γ}^{_{qk}}^{²}

c, Plug Gamma correction density D_{qk}′ into normally-black-monitor's gray balance component primary power function to calculate gray balance component primary value (used as gray core) and gray substitute parameter k_{dd}:

r_{dd}=(D_{qk}′)^{γ}^{_{rd}}=(D_{qk}^{1/γ}^{_{qk}}^{²})^{γ}^{_{rd}}=D_{qk}^{γ}^{_{rd}}^{/γ}_{qk}^{²}, g_{dd}=(D_{qk}′)^{γ}^{_{dg}}=D_{qk}^{γ}^{_{gd}}^{/γ}^{_{qk}}^{²}, b_{dd}=(D_{qk}′)^{γ}^{_{bd}}=D_{qk}^{γ}^{_{bd}}^{/γ}^{_{qk}}^{²}

Step 2, Map chromaticity coordinates xₙ and yₙ of input device profile connection space to television monitor, and then finish mapping with Liu's mapping equation:

Liu's 4-primary color gamut mapping equation has 3 sub-types: r_{dd}gb, rg_{dd}b, rgb_{dd}. There is one-to-one relationship between them and sub-types of Liu's color-segmentation equation; following are the 3 sub-types:

$$\{ \begin{matrix}( {x}_{n} / {y}_{n} ) {Y}_{qk} = \begin{matrix}( 1 - {r}_{dd} ) ( 1 - g ) ( 1 - b ) {X}_{k} + ( 1 - {r}_{dd} ) {g}_{d} ( 1 - b ) {X}_{m} + ( 1 - {r}_{dd} ) ( 1 - g ) b {X}_{y} + \\ ( 1 - {r}_{dd} ) g b {X}_{r} + {r}_{dd} ( 1 - g ) ( 1 - b ) {X}_{c} + {r}_{dd} ( 1 - g ) b {X}_{g} + {r}_{dd} g ( 1 - b ) {X}_{b} + {r}_{dd} g b {X}_{sw}\end{matrix} \\ {Y}_{qk} = ( 1 - {r}_{dd} ) ( 1 - g ) ( 1 - b ) {Y}_{k} + ( 1 - {r}_{dd} ) g ( 1 - b ) {Y}_{m} + ( 1 - {r}_{dd} ) ( 1 - g ) b {Y}_{y} + … + {r}_{dd} g b {Y}_{sw} \\ [ ( 1 - {x}_{n} - {y}_{n} ) / {y}_{n} ] {Y}_{qk} = ( 1 - {r}_{dd} ) ( 1 - g ) ( 1 - b ) {Z}_{k} + ( 1 - {r}_{dd} ) g ( 1 - b ) {Z}_{m} + ( 1 - {r}_{dd} ) ( 1 - g ) b {Z}_{y} + … + {r}_{dd} g b {Z}_{sw}\end{matrix} \\ \{ \begin{matrix}( {x}_{n} / {y}_{n} ) {Y}_{qk} = \begin{matrix}( 1 - r ) ( 1 - {g}_{dd} ) ( 1 - b ) {X}_{k} + ( 1 - r ) {g}_{dd} ( 1 - b ) {X}_{m} + ( 1 - r ) ( 1 - {g}_{dd} ) b {X}_{y} + \\ ( 1 - r ) {g}_{dd} b {X}_{r} + r ( 1 - {g}_{dd} ) ( 1 - b ) {X}_{c} + r ( 1 - {g}_{dd} ) b {X}_{g} + {r}_{d} g ( 1 - b ) {X}_{b} + r {g}_{dd} b {X}_{sw}\end{matrix} \\ {Y}_{qk} = ( 1 - r ) ( 1 - {g}_{dd} ) ( 1 - b ) {Y}_{k} + ( 1 - r ) {g}_{dd} ( 1 - b ) {Y}_{m} + ( 1 - r ) ( 1 - {g}_{dd} ) b {Y}_{y} + … + r {g}_{dd} b {Y}_{sw} \\ [ ( 1 - {x}_{n} - {y}_{n} ) / {y}_{n} ] {Y}_{qk} = ( 1 - r ) ( 1 - {g}_{dd} ) ( 1 - b ) {Z}_{k} + ( 1 - r ) {g}_{dd} ( 1 - b ) {Z}_{m} + ( 1 - r ) ( 1 - {g}_{dd} ) b {Z}_{y} + … + r {g}_{dd} b {Z}_{sw}\end{matrix} \\ \{ \begin{matrix}( {x}_{n} / {y}_{n} ) {Y}_{qk} = \begin{matrix}( 1 - r ) ( 1 - g ) ( 1 - {b}_{dd} ) {X}_{k} + ( 1 - r ) g ( 1 - {b}_{dd} ) {X}_{m} + ( 1 - r ) ( 1 - g ) {b}_{dd} {X}_{y} + \\ ( 1 - r ) g {b}_{dd} {X}_{r} + r ( 1 - g ) ( 1 - {b}_{dd} ) {X}_{c} + r ( 1 - g ) {b}_{dd} {X}_{g} + r g ( 1 - {b}_{dd} ) {X}_{b} + r g {b}_{dd} {X}_{sw}\end{matrix} \\ {Y}_{qk} = ( 1 - r ) ( 1 - g ) ( 1 - {b}_{dd} ) {Y}_{k} + ( 1 - r ) g ( 1 - {b}_{dd} ) {Y}_{m} + ( 1 - r ) ( 1 - g ) {b}_{dd} {Y}_{y} + … + r g {b}_{dd} {Y}_{sw} \\ [ ( 1 - {x}_{n} - {y}_{n} ) / {y}_{n} ] {Y}_{qk} = ( 1 - r ) ( 1 - g ) ( 1 - {b}_{dd} ) {Z}_{k} + ( 1 - r ) g ( 1 - {b}_{dd} ) {Z}_{m} + ( 1 - r ) ( 1 - g ) {b}_{dd} {Z}_{y} + … + r g {b}_{dd} {Z}_{sw}\end{matrix}$$

Choose a sub-type from r_{dd}gb, rg_{dd}b, rgb_{dd}; plug r_{dd}, g_{dd}, b_{dd} (calculated in step 1) into right side of equation; plug xₙ, yₙ and Liu's clamping luminance Y_{qk} into left side of equation to get Gamma corrected and gamut mapped reference primary value rgb and luminance value Y_{qk}.

In above equations, driving input value dᵣd_{g}d_{b} is also function of reference primary value rgb.

Following is the method to convert television monitor reference primary value rgb to driving input value RGB:)

R=d_{qk}=D_{qk}^{1/γ}^{_{qk}}=(r_{qk}^{1/γ}^{_{rdk}})^{1/γ}^{_{qk}}=r^{1/(γ}^{_{rd}}^{γ}^{_{qk)}}G=d_{qk}=D_{qk}^{1/γ}^{_{qk}}=(g_{qk}^{1/γ}^{_{gdk}})^{1/γ}^{_{qk}}=g^{1/(γ}^{_{gd}}^{γ}^{_{qk)}}B=d_{qk}=D_{qk}^{1/γ}^{_{qk}}=(b_{qk}^{1/γ}^{_{bdk}})^{1/γ}^{_{qk}}=b^{1/(γ}^{_{bd}}^{γ}^{_{qk)}}

The 3 primary values calculated respectively with 3 sub-types of Liu's comprehensive mapping equation are Gamma corrected primary value.

Let X_{qk}=(xₙ/yₙ)Yₙ, Y_{qk}=Yₙ, Z_{qk}=[(1−xₙ−yₙ)/yₙ]Yₙ, the final display color is X_{qk}, Y_{qk}, Z_{qk}. RGB is driving value used for displaying color X_{qk}, Y_{qk}, Z_{qk}.

(4) Method to map color XYZ captured by printer device to gamut of normally-white-monitor

Method: gamut mapping between printer device and display device is performed by mapping density parameter Dₚ of profile connection space to gray tone density parameter D_{pw} of target gamut, and transferring chromaticity coordinates xₚ and yₚ with the help of printer-monitor mapping equation.

Procedure:

Step 1, Map printer device color space's gray tone density Dₚ to display device gamut's gray tone density D_{q}:

a. Let D_{qw}=Dₚ^{γ}^{_{qwp}};

b. Calculate Gamma correction density: let D_{qw}′=d_{qw}^{1/γ}^{_{qw}}=D_{qw}^{1/γ}^{_{qw}}^{²};

Plug Gamma correction density Dₒ′ into printer's gray balance component primary power function to calculate gray balance component primary value(used as gray core) and gray substitute parameter kₚ:

r_{dd}=(D_{qw}′)^{γ}^{_{rd}}=(D_{qw}^{1/γ}^{_{qk}}^{²})^{γ}^{_{rd}}=D_{qw}^{γ}^{_{rd}}^{/γ}^{_{qk}}^{²}, g_{dd}=(D_{qw}′)^{γ}^{_{gd}}=D_{qw}^{γ}^{_{gd}}^{/γ}^{_{qk}}^{²}, b_{dd}=(D_{qw}′)^{γ}^{_{bd}}=D_{qw}^{γ}^{_{bd}}^{/γ}^{_{qk}}^{²}

Only r_{dd} or g_{dd} or b_{dd} need to be calculated based on the chosen type of printer—normally-white-monitor gamut mapping equation.

c. Plug r_{dd}, g_{dd} or b_{dd} into right side of chosen type of printer—normally-black-monitor gamut mapping equation;

Step 2, Map printing device profile connection space chromaticity coordinates xₚ and yₚ to gamut of display device using Liu's printer—normally-white-monitor gamut mapping equation. The 3 sub-types of equation r_{dd}gb, rg_{dd}b, rgb_{dd} are as follows:

$$\{ \begin{matrix}( {x}_{p} / {y}_{p} ) {Y}_{qw} = \begin{matrix}( 1 - {r}_{dd} ) ( 1 - g ) ( 1 - b ) {X}_{w} + ( 1 - {r}_{dd} ) {g}_{d} ( 1 - b ) {X}_{m} + ( 1 - {r}_{dd} ) ( 1 - g ) b {X}_{y} + \\ ( 1 - {r}_{dd} ) g b {X}_{r} + {r}_{dd} ( 1 - g ) ( 1 - b ) {X}_{c} + {r}_{dd} ( 1 - g ) b {X}_{g} + {r}_{dd} g ( 1 - b ) {X}_{b} + {r}_{dd} g b {X}_{sk}\end{matrix} \\ {Y}_{qw} = ( 1 - {r}_{dd} ) ( 1 - g ) ( 1 - b ) {Y}_{w} + ( 1 - {r}_{dd} ) g ( 1 - b ) {Y}_{m} + ( 1 - {r}_{dd} ) ( 1 - g ) b {Y}_{y} + … + {r}_{dd} g b {Y}_{sk} \\ [ ( 1 - {x}_{p} - {y}_{p} ) / {y}_{p} ] {Y}_{qw} = ( 1 - {r}_{dd} ) ( 1 - g ) ( 1 - b ) {Z}_{w} + ( 1 - {r}_{dd} ) g ( 1 - b ) {Z}_{m} + ( 1 - {r}_{dd} ) ( 1 - g ) b {Z}_{y} + … + {r}_{dd} g b {Z}_{sk}\end{matrix} \\ \{ \begin{matrix}( {x}_{p} / {y}_{p} ) {Y}_{qw} = \begin{matrix}( 1 - r ) ( 1 - {g}_{dd} ) ( 1 - b ) {X}_{w} + ( 1 - r ) {g}_{dd} ( 1 - b ) {X}_{m} + ( 1 - r ) ( 1 - {g}_{dd} ) b {X}_{y} + \\ ( 1 - r ) {g}_{dd} b {X}_{r} + r ( 1 - {g}_{dd} ) ( 1 - b ) {X}_{c} + r ( 1 - {g}_{dd} ) b {X}_{g} + {r}_{d} g ( 1 - b ) {X}_{b} + r {g}_{dd} b {X}_{sk}\end{matrix} \\ {Y}_{qw} = ( 1 - r ) ( 1 - {g}_{dd} ) ( 1 - b ) {Y}_{w} + ( 1 - r ) {g}_{dd} ( 1 - b ) {Y}_{m} + ( 1 - r ) ( 1 - {g}_{dd} ) b {Y}_{y} + … + r {g}_{dd} b {Y}_{sk} \\ [ ( 1 - {x}_{p} - {y}_{p} ) / {y}_{p} ] {Y}_{qw} = ( 1 - r ) ( 1 - {g}_{dd} ) ( 1 - b ) {Z}_{w} + ( 1 - r ) {g}_{dd} ( 1 - b ) {Z}_{m} + ( 1 - r ) ( 1 - {g}_{dd} ) b {Z}_{y} + … + r {g}_{dd} b {Z}_{sk}\end{matrix} \\ \{ \begin{matrix}( {x}_{p} / {y}_{p} ) {Y}_{qw} = \begin{matrix}( 1 - r ) ( 1 - g ) ( 1 - {b}_{dd} ) {X}_{w} + ( 1 - r ) g ( 1 - {b}_{dd} ) {X}_{m} + ( 1 - r ) ( 1 - g ) {b}_{dd} {X}_{y} + \\ ( 1 - r ) g {b}_{dd} {X}_{r} + r ( 1 - g ) ( 1 - {b}_{dd} ) {X}_{c} + r ( 1 - g ) {b}_{dd} {X}_{g} + r g ( 1 - {b}_{dd} ) {X}_{b} + r g {b}_{dd} {X}_{sk}\end{matrix} \\ {Y}_{qw} = ( 1 - r ) ( 1 - g ) ( 1 - {b}_{dd} ) {Y}_{w} + ( 1 - r ) g ( 1 - {b}_{dd} ) {Y}_{m} + ( 1 - r ) ( 1 - g ) {b}_{dd} {Y}_{y} + … + r g {b}_{dd} {Y}_{sk} \\ [ ( 1 - {x}_{p} - {y}_{p} ) / {y}_{p} ] {Y}_{qw} = ( 1 - r ) ( 1 - g ) ( 1 - {b}_{dd} ) {Z}_{w} + ( 1 - r ) g ( 1 - {b}_{dd} ) {Z}_{m} + ( 1 - r ) ( 1 - g ) {b}_{dd} {Z}_{y} + … + r g {b}_{dd} {Z}_{sk}\end{matrix}$$

In above equation, driving input value dᵣd_{g}d_{b} is also function of reference primary value rgb;

hence normally-white-monitor reference primary value rgb can be converted to driving input value RGB as follows:

R=d_{qw}=D_{qw}^{1/γ}^{_{qw}}=(r_{qw}^{1/γ}^{_{rdw}})^{1/γ}^{_{qw}}=r^{1/(γ}^{_{rd}}^{γ}^{_{qw)}}G=d_{qw}=D_{qw}^{1/γ}^{_{qw}}=(g_{qw}^{1/γ}^{_{gdw}})^{1/γ}^{_{qw}}=g^{1/(γ}^{_{gd}}^{γ}^{_{qw)}}B=d_{qw}=D_{qw}^{1/γ}^{_{qw}}=(b_{qw}^{1/γ}^{_{bdw}})^{1/γ}^{_{qw}}=b^{1/(γ}^{_{bd}}^{γ}^{_{qw)}}

3 primary values calculated respectively using 3 sub-types of Liu's comprehensive mapping equation are all Gamma corrected primary values.

Let X_{qw}=(xₙ/yₙ)Yₜ, Y_{qw}=Yₜ, Z_{qw}=[(1−xₙ−yₙ)/yₙ]Yₜ, and final display color is X_{qw}, Y_{qw}, Z_{qw} and RGB is driving value required for displaying color X_{qw}, Y_{qw}, Z_{qw}.

### IV DESCRIPTION OF DRAWING

FIG. 1, Flow diagram of gamut mapping from scanner to printer device color space, and from printer device color space to monitor device color space:

Predicted color based on color target scanned by scanner→transform predicted color to Liu's Dₗxₗyₗ profile connection space→transform to printer device color space→transform to display device color space;

FIG. 2, Flow diagram of converting color RGB captured by digital camera into XYZ and calculating computer monitor's driving value RGB based on XYZ;

FIG. 3, Flow diagram of converting color RGB captured by digital video camera or television camera into XYZ value and calculating television monitor driving value RGB based on XYZ.

### V. APPLICATION STEPS

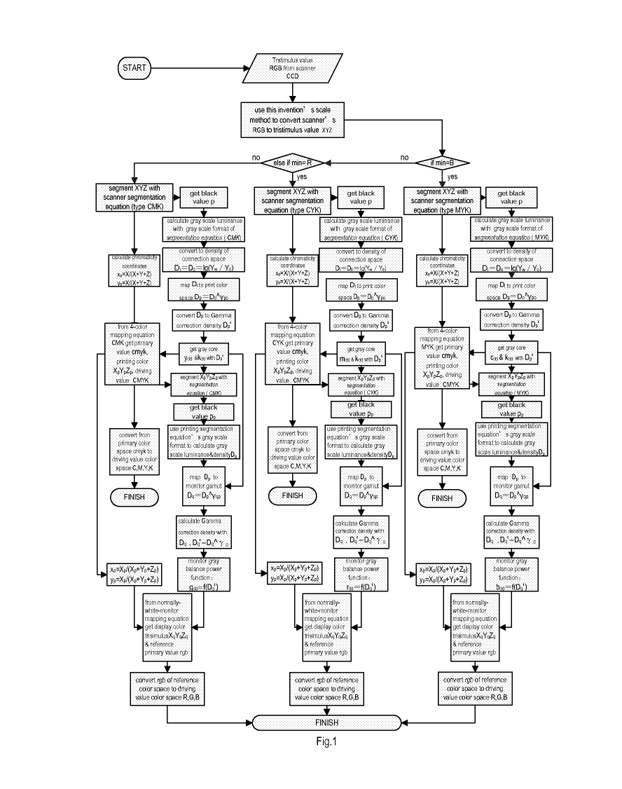

1. Refer to FIG. 1, the following mapping flow is used to highlight this invention's generality, creativity and efficiency features: “predicted color XYZ based on scanned RBG from scanner→transform color XYZ to Liu's Dₗxₗyₗ profile connection space→segment color XYZ to get driving input value CMYK→produce pre-proofing color image on normally-white-monitor”

(1) Convert R,G,B into tristimulus values X,Y,Z using the method mentioned in this invention;

(2) Observe tristimulus value R,G,B captured by scanner's CCD device, choose proper RGB segmentation equation based on the smallest value in R,G,B.

The selection criteria are:

if B has smallest value, use Liu's scan segmentation equation-type MYK;

if R has smallest value, use Liu's scan segmentation equation-type CYK;

if G has smallest value, use Liu's scan segmentation equation-type CMK;

We will take type MYK of Liu's scan segmentation equation as example, other two scenarios can be done in similar manner;

(3) Plug target value XYZ on left side of Liu's scan segmentation equation (type MYK), solve the equation to get black vale p;

(4) Plug black value p into gray scale format of Liu's scan segmentation equation to get gray luminance tristimulus value Yₗ as Yₗ=Y_{wo}(1−p)+p Yₛₖ;

(5) Convert Yₗ to density value Dₒ: let Dₒ=Dₗ=lg(Y_{wo}/Yₗ), in which Y_{wo} is luminance tristimulus value measured on white area of scan target;

(6) Convert tristimulus value XYZ into chromaticity coordinates xₒ and yₒ, as follows:

$${x}_{o} = {x}_{l} = \frac{X}{X + Y + Z} \qquad {y}_{o} = {y}_{l} = \frac{Y}{X + Y + Z}$$

After above steps, the transformation from RGB color space to CIEXYZ color space to Dₗxₗyₗ profile connection space is done; next step is to transfer value Dₒ, xₒ, yₒ to printer module;

(7) Map Dₒ of scanner profile connection space to printer space: let Dₚ=Dₒ^{γ}^{ₚₒ};

(8) Calculate Gamma correction density based on Dₚ: Dₚ′=Dₚ^{1/γ}^{ₚ}^{²};

(9) Plug Gamma correction density Dₚ′ into printer's gray balance polynomial to calculate gray substitute parameter k_{dd}, c_{dd}, and component primary which is used as gray core.

cₚ=c_{dd}=a₀+a₁Dₚ′+a₂Dₚ′²+a₃Dₚ′³+ . . . , kₚ=k_{dd}=d₀+d₁Dₚ′+d₂Dₚ′²+d₃Dₚ′³+ . . .

Please note: we only need to calculate k_{dd}, c_{dd}, or k_{dd}, m_{dd} or k_{dd}, y_{dd} depends on which type of 4-primary mapping equation is chosen;

(10) Plug k_{dd}, c_{dd} into right side of chosen 4-primary mapping equation (type MYK) to get primary value: k=k_{dd}, c=c_{dd}, m and y;

(11) Convert primary value k, c, m, y into driving value CMYK;

(12) Calculate color XₚYₚZₚ which is mapped from scanner gamut to printer gamut;

Xₚ=(xₒ/yₒ)Yₚ, Yₚ=Yₚ, Zₚ=[(1−xₒ−yₒ)/yₒ]Yₚ

(13) Map printer (press) gray tone density array [Dₚᵢ] to gamut of display device: D_{q}=Dₚ^{γ}^{_{qp}}

(14) Calculate Gamma correction value D_{q}′ of density value D_{q}: D_{q}′=D_{q}^{1/γ}^{_{q}}^{²}

(15) Substitute variable D_{q} in monitor gray balance polynomial with D_{q}′ to get gray core value c_{dd};

(16) Convert calculated tristimulus value XₚYₚZₚ into chromaticity coordinates xₚ and yₚ:

$${x}_{l} = {x}_{p} = \frac{{X}_{p}}{{X}_{p} + {Y}_{p} + {Z}_{p}} \qquad {y}_{l} = {y}_{p} = \frac{{Y}_{p}}{{X}_{p} + {Y}_{p} + {Z}_{p}}$$

(17) Plug c_{dd}, xₚ, yₚ into monitor's additive mapping equation (type RGK) to get primary r, g, b=b_{dd}, and display color's tristimulus value X_{q}Y_{q}Z_{q};

(18) In order to display target color X_{q}Y_{q}Z_{q} on monitor, next step is to transform primary value rgb into their driving color space:

R=r^{1/(γ}^{_{rd}}^{γ}^{_{qw)}}, G=g^{1/(γ}^{_{gd}}^{γ}^{_{qw)}}, B=b^{1/(γ}^{_{bd}}^{γ}^{_{qw)}}

Use RGB as driving value for monitor to display a ready to print pre-proof image.

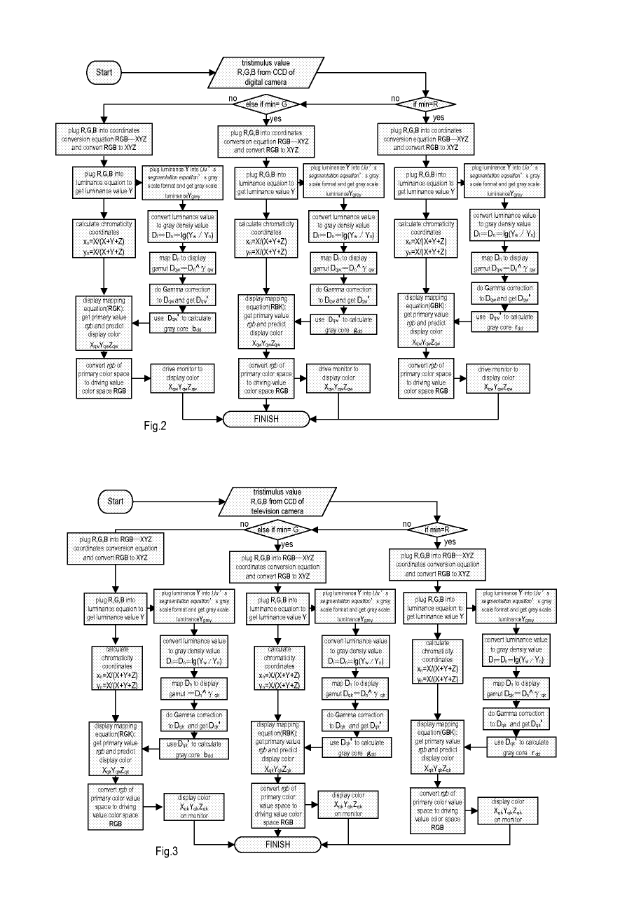

2. Refer to FIG. 2, the following mapping flow is used to highlight this invention's generality, creativity and efficiency features in gamut mapping.

Digital camera predicted color XYZ based on CCD censored RGB valuetransform predicted color XYZ to Liu's Dₗxₗyₗ profile connection space→segment color XYZ to get driving input value RGB→produce color image on monitor.

(1) Plug R,G,B into color coordinate conversion formula RGB-XYZ to convert RGB into XYZ;

(2) Plug R,G,B into luminance equation to get luminance value Y;

(3) Plug luminance value Y into gray scale format of Liu's segmentation equation to get gray scale luminance value Y_{gray};

(4) Convert luminance value into gray density value Dₗ=Dₙ=lg(Y_{w}/Yₙ);

(5) Map Dₙ to monitor gamut density D_{qw}=Dₙ̂γ_{qw}; perform Gamma correction on D_{qw} to get D_{qw}′;

(6) Calculate gray core r_{dd} based on D_{qw}′, then plug gray core r_{dd} into monitor mapping equation (type GBK);

(7) Convert color's tristimulus XYZ into Chromaticity coordinates xₙ and yₙ:

$${x}_{n} = {x}_{l} = \frac{X}{X + Y + Z} \qquad {y}_{n} = {y}_{l} = \frac{Y}{X + Y + Z}$$

(8) Plug xₙ and yₙ into monitor mapping equation (type GBK);

(9) Solve monitor mapping equation (type GBK) to get primary value rgb and pre-proof display color X_{qw}Y_{qw}Z_{qw};

(10) Convert rgb in primary color space to driving values RGB, then use RGB to ‘drive’ monitor to display color image shot by digital camera on monitor;

3. Refer to FIG. 3, the following mapping flow is used to highlight this invention's generality, creativity and efficiency features in gamut mapping.

Television camera or digital video camera (DV) predicted color XYZ based on CCD censored RGB value→transform predicted color XYZ to Liu's Dₗxₗyₗ profile connection space→segment color XYZ to get TV driving input value RGB→produce television image on monitor.

(1) Plug R,G,B into color coordinate conversion formula RGB-XYZ to convert RGB into XYZ;

(2) Plug R,G,B into luminance equation to calculate luminance value Y;

(3) Plug luminance value Y into gray scale format of Liu's segmentation equation to get gray scale luminance value Y_{gray};

(4) Convert luminance value into gray density value Dₗ=Dₙ=lg(Y_{w}/Yₙ);

(5) Map Dₙ to monitor gamut density D_{qk}=Dₙ̂γ_{qk} and perform Gamma correction on D_{qk} to get D_{qk}′;

(6) Calculate gray core r_{dd} based on D_{qk}′, then plug gray core r_{dd} in monitor mapping equation (type GBK);

(7) Convert color's tristimulus value XYZ into chromaticity coordinates xₙ and yₙ:

$${x}_{n} = {x}_{l} = \frac{X}{X + Y + Z} \qquad {y}_{n} = {y}_{l} = \frac{Y}{X + Y + Z}$$

(8) Plug xₙ and yₙ into television monitor mapping equation (type GBK);

(9) Solve above equation to get primary value rgb and pre-proof display color X_{qk}Y_{qk}Z_{qk};

(10) Convert primary value rgb into driving values RGB, then use RGB to drive television monitor, color image shot by television video camera will be displayed on monitor;

After comparing FIG. 2 and FIG. 3, we can conclude there is no essential difference between them except white and black field are swapped.

1. A universal gamut mapping and color management method, and its characteristics are:
a. this invention creates a method to do gamut mapping conform to visual effect, thus the mapped color keeps original hue, chromaticity coordinates and luminance which conforms to visual effect;
b. to avoid system and random error in color space conversion, this invention adopts calibration target with same structure, perform coordinates conversion in color space and gamut mapping among devices in accordance with same principle and method;
c. Primary color's hue is always the same through the whole gamut mapping process flow;
d. this invention creates channel primary parameter and reversible power function relationship between channel primary value, reference primary value and driving parameter value; this ensures accuracy of color prediction; driving parameter, reference primary value and channel primary value play important roles in color management system;
e. this invention creates a method to generate pure gray scale, and based upon this, it creates gray core parameter, gray balance function and Gamma correction method using density as parameter, thus it ensures image's gray balance and prioritized reproduction of gray tone;
f. this invention creates a method to precisely segment color into gray component and secondary color component, and based upon this, it creates Liu's Dₗxₗyₗ profile connection space;
g. this invention creates color space mapping method that can perform gamut mapping and Gamma correction at same time; it can be implemented with analytical algorithm quickly;
h. a method to accurately convert primary value derived from Liu's gamut mapping equation to driving value;
i. a gamut mapping method among devices;
j. in order to achieve this universal gamut mapping and color management method, description of this invention covered a set of Liu's color-matching equations, including Liu's color-matching equation based on subtractive color reproduction, Liu's color-matching equation based on additive color reproduction, Liu's color-matching equation based on 4-primary color reproduction, Liu's scanning color prediction equation and RGB scanning color-segmentation equation, etc;
Each equation, formula, concept or phrase that begins with Liu's is creative achievement of this invention, and is part of this claim and its requirements for protection of rights;

2. A target structure according to claim 1, wherein generalizing cross-media color gamut mapping method, and its characteristics are: color target used to calibrate input and output devices are sample colors generated with same scale level and identical driving value;

3. a primary hue keeping method according to claim 1, and its characteristics are:
a. Liu's primary clamping equation and Liu's reference primary color formula are the fundamental technology behind this method;
b. use Liu's primary clamping equation to perform clamping process to the measured value on 3-primary scale in order to get the sample color's clamping luminance value;
c. Liu's reference primary formula derived from Liu's primary clamping equation helps to predict primary component's hue and keep hue consistent; the color predicted by the formula shares the same hue as unit primary value;
d. the tristimulus value of reference primary always equal to XYₜZ; X and Z are sample color's measured tristimulus value; Yₜ is clamping luminance derived from Liu's primary clamping equation;
e. Liu's color appearance keeping coefficient λ is a parameter related to wave length of primary color;

4. A method according to claim 1, wherein predicting color-matching result accurately using Liu's color-matching equation, and its characteristics are:
a. Liu's color prediction equation is the main and key technology behind this method which includes: Liu's color-matching equation based on subtractive color reproduction, Liu's color-matching equation based on additive color reproduction, Liu's 4-primary color-matching equation based on 4-primary reproduction, scan color prediction equation and RGB scan color segmentation equation;
b. in Liu's color-matching equation, every primary color has its own channel primary parameter in each channel; there exists reversible power function relationship between channel primary parameter and reference primary color; the same goes with relationship between reference primary color and driving parameter;
c. Liu's color-matching equation can predict primary synthesis result accurately;
d. RGB scan color separation equation and Liu's scan color prediction equation are twin equations describing the same sample color;

5. A method according to claim 1, wherein characterizing Liu's color-matching equation and its characteristics are:
a. use Liu's primary clamping equation and Liu's reference primary formula to calibrate sample color on three primaries scale and give primary color independent color-matching feature;
b. calibrate primary color's three channel primary value using primary scale's reference primary series to ensure space independency of each primary in 3 dimension color-matching space;
c. this method establishes power function relationship between reference primary parameter and color driving value;

6. A method according to claim 1, wherein creating pure gray scale for scanner, printer, normally-white-monitor and normally-black-monitor, and its characteristics are:
a. use the pure gray scale created with this invention as basic model of gray tone reproduction;
b. the source data for creating pure gray scale are initial luminance array [Yₒₐᵢ], [Gₒₐᵢ], [Yₚₐᵢ], [Y_{qwai}], [Y_{qkai}] measured on color scale displayed on scanner, printer and monitor; based on these source data, the ideal luminance arrays of pure gray scale without optical distortion are created after nine conversion steps; the optical distortion is eliminated using special power function fitting method;
c. on pure gray scale, chromaticity coordinates of every dot is identical to that of media white dot;

7. A method according to claim 1, wherein characterizing pure gray scale component primary value; and its characteristics are:
a. pure gray scale component primary value is the result of calibrating tristimulus array of pure gray scale using Liu's color-matching equation;
b. pure gray scale component primary value is power function with pure gray density as independent variable; for 4-primary printing, it is polynomial function with pure gray density as independent variable;
c. the minimum value in pure gray scale component primary is considered the gray core;
d. Gray core is used as a tool for prioritizing gray tone reproduction, a carrier for Gamma correction and key to fast analytical operations;
e. in pure gray scale component primary polynomial function created for 4-primary printer device, black primary value is purified reference primary value;
f. let k_{dd}=Q(dₖ̂γₖ)ⁿ, in which k_{dd} represents gray component substitute value;
g. the 4-primary gray balance polynomial calibration method is: pre-define black primary color's tone curve to convert 4-primary color-matching equation into 3-primary color-matching equation, then perform calibration on 3 primaries gray balance polynomial using 3-primaries color-matching equation;

8. A method according to claim 1, wherein performing Gamma correction on image gray tone, and its characteristics are:
a. pure gray density of pure gray scale is used as Gamma correction parameter;
b. Gamma value equals to 2;
c. cmyk 4-primary reproduction is done by substituting pure gray density parameter D in gray balance polynomial with Gamma correction density D; in other words, it is accomplished by using Liu's 4-primary printing anti-Gamma gray balance polynomial;

9. A method according to claim 1, wherein creating Dₗxₗyₗ profile connection color space for scanner and its characteristics are:
a. Liu's color segmentation equation and its gray scale format are important tool and essential technology to create Dₗxₗyₗ profile connection color space;
b. perform color segmentation on scanned color XYZ using Liu's color segmentation equation to get gray color p, XYZ is derived from Liu's scan color prediction equation;
c. this method performs color clamping on gray component using parameter p and on color component using parameter (1−p);
d. density parameter Dₗ of Dₗxₗyₗ profile connection color space depends on parameter p; density parameter Dₗ is calculated using gray scale format of Liu's color segmentation equation; chromaticity parameter xₗyₗ depends on segmentation color XYZ;
e. Liu's scan color segmentation equation has 3 sub-types; it divides the color to-be-segmented into 3 areas;
f. when transforming or compressing color XYZ to target color space, Dₗxₗyₗ color space has high compression ratio, constant luminance and chromaticity;
g. Liu's color segmentation equation can be simplified to ternary quadratic equation for fast operation;

10. A method according to claim 1, wherein calculating twin primary value c′m′y′ for scanner in RGB color space with Liu's 3-primary clamping equation, and its characteristics are:
a. Liu's 3-primary clamping equation introduced in this invention is an efficient tool and core technology for calculating twin primary value c′m′y′;
b. Liu's 3-primary clamping equation performs clamping on twin primary value c′m′y′ using color appearance keeping parameter λ and gray core parameter to ensure c′m′y′ possessing reference primary characteristics, meanwhile the hue and chromaticity coordinates of color RGB stay unchanged;
c. Liu's 3-primary clamping equation is ternary quadratic equation and can be solved quickly using analytic method;

11. A method according to claim 1, wherein converting scanned color from RGB color space to CIEXYZ color space, and its characteristics are:
a. it is a conversion method in accordance with chromaticity theory instead of an approximation methods based on regression analysis theory;
b. calculating gray core parameter with Liu's color segmentation equation ensures calculation accuracy of gray component in color RGB;
c. Liu's 3-primary clamping equation ensures the hue independency of twin primary value c′m′y′;
d. c′m′y′-cmy twin primary conversion expression mentioned in this invention helps to convert color coordinate accurately;
e. RGB to XYZ conversion is carried out using scan color prediction equation mentioned in this invention;
f. RGB-XYZ coordinate conversion is carried out using RGB scan color segmentation equation and Liu's scan color predication equation;

12. A method according to claim 1, wherein creating Dₗxₗyₗ profile connection color space for digital camera or digital television camera, and its characteristics are:
a. calculate tristimulus value of gray tone on standard monitor using gray scale equation in Liu's color segmentation equation; the clamping parameter Y in this equation is luminance value derived from luminance equation;
b. calculate gray tone luminance Y_{grey} using luminance equation in Liu's gray scale equation based on luminance value Y of color XYZ, then convert Y_{grey} to density parameter Dₗ in color connection space;
c. calculate xₗ, yₗ of Dₗxₗyₗ profile connection color space using XYZ derived from RGB-XYZ matrix equation;
d. the method to create Dₗxₗyₗ profile connection color space can be universally applied to various types of display devices such as CRT, PDP, LCD, LED, etc;

13. A method according to claim 1, wherein mapping parameter Dₗ in profile connection space to gamut of target device, and its characteristics are:
a. establish power function relationship between profile connection space parameter Dₗ and pure gray tone density of target device gamut to achieve gray tone mapping objective; this method can be universally applied to various types of output devices;
b. the method of performing gray tone mapping using pure gray density parameter is not only applicable to different type of devices, but also applicable to devices producing color based on additive or subtractive method;

14. A method according to claim 1, wherein mapping color Dₗxₗyₗ in profile connection space to gamut of target device, and its characteristics are:
a. Liu's gamut mapping equation is the core technology to implement this method;
b. color Dₗxₗyₗ in profile connection space is provided to Liu's gamut mapping equation on two streams and intersect in Liu's gamut mapping equation;
c. the channels transferring Dₗ perform Gamma correction on gray tone, then calculate gray core parameter based on Gamma correction density, finally plug gray core value dynamically into Liu's gamut mapping equation;
d. plug chromaticity parameter xₗyₗ into Liu's gamut mapping equation, along with Liu's clamping luminance Yₚ, Y_{qw}, Y_{qk} and gray core value to perform clamping on Liu's gamut mapping equation;
e. Liu's gamut mapping equation is a color segmentation engine; the reference primary values derived from it all inherit hue constant characteristics;
f. primary driving input value can be calculated based on reference primary value derived from Liu's gamut mapping equation;
g. Liu's gamut mapping equation is ternary quadratic equation and can be solved using analytical algorithm;

15. A method according to claim 1, wherein mapping color XYZ captured by scanner to gamut of printing device; it inherits all the general characteristics of Liu's gamut mapping method and also has the following characteristics:
a. gamut mapping is carried out with the help of Liu's scanner-printer mapping equation;
b. this method calculates component primary value of gray tone and gray substitute parameter k_{dd} using Liu's 4-primary printing anti-Gamma gray balance polynomial Gray component primary value is used to calculate gray tone Gray component parameter k_{dd} is a Gamma corrected gray component substitute parameter with pure tone distribution curve;
c. the color XₚYₚZₚ produced after mapping is the predicted color to be printed;
d. the driving value CMYK which produces color XₚYₚZₚ is calculated based on reference primary cmy and k_{dd} derived from Liu's scanner-printer mapping equation; CMYK is represented using double Gamma correction function;

16. A method according to claim 1, wherein mapping color XYZ captured by digital camera to gamut of normally-white-monitor; it inherits all the general characteristics of Liu's gamut mapping method and has the following characteristics:
a. gamut mapping is carried out with the help of Liu's digital camera-monitor mapping equation;
b. Liu's digital camera-monitor mapping equation has three sub types With join effort of Y_{qw} and r_{dd}, Y_{qw} and g_{dd}, Y_{qw} and b_{dd}, the method ensures the color mapped to target gamut can inherit its hue and chromaticity in source gamut, and the luminance distribution of both colors has decent similarity;
c. the color X_{qw} Y_{qw} Z_{qw} produced after mapping is the predicted color on normally-white-monitor;
d. the driving input value RGB of color X_{qw} Y_{qw} Z_{qw} produced by normally-white-monitor is calculated based on reference primary rgb derived from Liu's digital camera-monitor mapping equation RGB is represented using double Gamma correction function;

17. A method according to claim 1, wherein mapping color XYZ captured by television camera or digital video camera to gamut of normally-black-monitor; it inherits all the general characteristics of Liu's gamut mapping method and has the following characteristics:
a. gamut mapping is carried out with the help of Liu's television camera—TV monitor mapping equation;
b. Liu's television camera—TV monitor mapping equation has 3 sub-types; with join effort of Y_{qk} and r_{dd}, Y_{qk} and g_{dd}, Y_{qk} and b_{dd}, the method ensures the color mapped to target gamut inherits its hue and chromaticity in source gamut, also the luminance distribution of both colors has decent similarity;
c. the color X_{qk} Y_{qk} Z_{qk} produced after mapping is the predicted color on normally-black-monitor;
d. the driving input value RGB of color X_{qk} Y_{qk} Z_{qk} produced by normally-black-monitor is calculated based on reference primary rgb derived from Liu's television camera—TV monitor mapping equation RGB is represented using double Gamma correction function;

18. A method according to claim 1, wherein mapping color XYZ generated by printer device to gamut of normally-white-monitor; it inherits all the general characteristics of Liu's gamut mapping method and also has the following characteristics:
a. gamut mapping is carried out with the help of Liu's printer—normally-white-monitor mapping equation;
b. Liu's printer—normally-white-monitor mapping equation has 3 sub-types; the method ensures the color mapped to target gamut can inherit its hue and chromaticity in source gamut, and the luminance distribution of both colors has decent similarity;
c. the mapped color X_{qk}Y_{qk}Z_{qk} is the preview of color on normally-white-monitor;
d. the driving input value RGB of color X_{qw}Y_{qw}Z_{qw} generated by normally-white-monitor is calculated based on reference primary rgb derived from Liu's printer—normally-white-monitor mapping equation; RGB is represented using double Gamma correction function;

19. A double Gamma correction method according to claim 1, wherein converting device's reference primary value to driving input value; its characteristics are:
a. this method can be universally applied to devices producing color based on either additive or subtractive color theory;
b. calculating input driving value based on reference primary value generated with mapping method is an anti-Gamma tone correction method with dual correction feature; it performs anti-Gamma correction on both primary tone itself and pure gray tone.
